(19) United States
(12) Patent Application Publication
(10) Pub. No.: US 2025/0167866 A1
(43) Pub. Date: May 22, 2025

(54) MULTIPLE STAGES OF BEAMFORMING FOR REFLECTIVE SURFACES

(71) Applicant: QUALCOMM Incorporated, San Diego, CA (US)

(72) Inventors: Ahmed ELSHAFIE, San Diego, CA (US); Hung Dinh LY, San Diego, CA (US); Muhammad Sayed Khairy ABDELGHAFFAR, San Jose, CA (US); Yu ZHANG, San Diego, CA (US)

(21) Appl. No.: 18/834,849

(22) PCT Filed: Apr. 12, 2022
(86) PCT No.: PCT/CN2022/086292

§ 371 Date: Jul. 31, 2024

(51) Int. Cl. H04B 7/06; H04B 7/04

(52) U.S. Cl. CPC H04B 7/06958; H04B 7/04013

(57) ABSTRACT

Methods, systems, and devices for wireless communications are described that support multiple stages of beamforming for a reconfigurable intelligent surface (RIS). A network entity may configure a RIS controller and a user equipment (UE) with a multi-stage beamforming configuration for a RIS. The configuration may be associated with multiple stages of beamforming that include a first stage and one or more second stages that refine one or more characteristics of the first stage. The network entity may also transmit a message indicating a beam training procedure for one or more of the multiple stages, where the beam training procedure may include communicating reference signals between the network entity and the UE, via the RIS. The network entity and the UE may perform the beam training procedure, and based on a result of the beam training procedure the RIS controller may configure one or more beamforming matrices for the RIS.

### CROSS REFERENCE

The present Application is a 371 national phase filing of International PCT Application No. PCT/CN2022/086292 by ELSHAFIE et al., entitled “MULTIPLE STAGES OF BEAMFORMING FOR REFLECTIVE SURFACES,” filed Apr. 12, 2022, which is assigned to the assignee hereof, and which is expressly incorporated by reference in its entirety herein.

### FIELD OF TECHNOLOGY

The following relates to wireless communications, including multiple stages of beamforming for reflective surfaces.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE).

In some cases, a UE and a network entity may communicate via signals that may be reflected off of a surface, such as a reconfigurable intelligent surface (RIS).

### SUMMARY

The described techniques relate to improved methods, systems, devices, and apparatuses that support multiple stages of beamforming for reflective surfaces (e.g., for a reconfigurable intelligent surface (RIS)). A network entity may configure a RIS controller and a user equipment (UE) with a multi-stage beamforming configuration for an associated RIS, where the multi-stage beamforming configuration may be associated with multiple stages that include a first stage and one or more second stages (e.g., that refine one or more characteristics of the first stage). The network entity may also transmit a message (e.g., to the RIS controller and the UE) indicating a beam training procedure for one or more of the multiple stages, where the beam training procedure may include communicating reference signals (RSs) between the network entity and the UE, via the RIS. Based on the configuration and the indication of the beam training procedure, the RIS controller may configure the RIS with element weights corresponding to the one or more stages associated with the beam training procedure. The network entity and the UE may perform the beam training procedure (e.g., communicate RSs via the RIS), and based on a result of the beam training procedure the RIS controller may configure one or more beamforming matrices for the RIS, for the one or more stages associated with the beam training procedure.

A method for wireless communication at a controller of a RIS is described. The method may include receiving, from a network entity, a first message indicating a multi-stage beamforming configuration for the RIS, the multi-stage beamforming configuration pertaining to a set of multiple stages that includes a first stage and one or more second stages that each refine one or more characteristics of the first stage, receiving a second message indicating a beam training procedure for at least one of the set of multiple stages of the multi-stage beamforming configuration, determining one or more beamforming matrices for the at least one of the set of multiple stages based on the beam training procedure, and applying the one or more beamforming matrices to the RIS for communications by the network entity using the at least one of the set of multiple stages.

An apparatus for wireless communication at a controller of a RIS is described. The apparatus may include a processor, memory coupled with the processor, and instructions stored in the memory. The instructions may be executable by the processor to cause the apparatus to receive, from a network entity, a first message indicating a multi-stage beamforming configuration for the RIS, the multi-stage beamforming configuration pertaining to a set of multiple stages that includes a first stage and one or more second stages that each refine one or more characteristics of the first stage, receive a second message indicating a beam training procedure for at least one of the set of multiple stages of the multi-stage beamforming configuration, determine one or more beamforming matrices for the at least one of the set of multiple stages based on the beam training procedure, and apply the one or more beamforming matrices to the RIS for communications by the network entity using the at least one of the set of multiple stages.

Another apparatus for wireless communication at a controller of a RIS is described. The apparatus may include means for receiving, from a network entity, a first message indicating a multi-stage beamforming configuration for the RIS, the multi-stage beamforming configuration pertaining to a set of multiple stages that includes a first stage and one or more second stages that each refine one or more characteristics of the first stage, means for receiving a second message indicating a beam training procedure for at least one of the set of multiple stages of the multi-stage beamforming configuration, means for determining one or more beamforming matrices for the at least one of the set of multiple stages based on the beam training procedure, and means for applying the one or more beamforming matrices to the RIS for communications by the network entity using the at least one of the set of multiple stages.

A non-transitory computer-readable medium storing code for wireless communication at a controller of a RIS is described. The code may include instructions executable by a processor to receive, from a network entity, a first message indicating a multi-stage beamforming configuration for the RIS, the multi-stage beamforming configuration pertaining to a set of multiple stages that includes a first stage and one or more second stages that each refine one or more characteristics of the first stage, receive a second message indicating a beam training procedure for at least one of the set of multiple stages of the multi-stage beamforming configuration, determine one or more beamforming matrices for the at least one of the set of multiple stages based on the beam training procedure, and apply the one or more beamforming matrices to the RIS for communications by the network entity using the at least one of the set of multiple stages.

In some examples of the method, apparatuses, and non-transitory computer-readable medium described herein, receiving the first message may include operations, features, means, or instructions for receiving an indication of the multi-stage beamforming configuration, where, in accordance with the multi-stage beamforming configuration, the first stage may be associated with one or more first channel characteristics and at least one of the one or more second stages may be associated with one or more second channel characteristics that may be of shorter duration than the one or more first channel characteristics.

In some examples of the method, apparatuses, and non-transitory computer-readable medium described herein, receiving the first message may include operations, features, means, or instructions for receiving an indication of the multi-stage beamforming configuration, where, in accordance with the multi-stage beamforming configuration, the first stage may be associated with a wideband frequency band and at least one of the one or more second stages may be associated with a narrowband frequency band that includes a subset of frequencies of the wideband frequency band.

In some examples of the method, apparatuses, and non-transitory computer-readable medium described herein, receiving the first message may include operations, features, means, or instructions for receiving an indication of the multi-stage beamforming configuration, where, in accordance with the multi-stage beamforming configuration, the first stage may be associated with a common beam for uplink and downlink communications and at least one of the one or more second stages may be associated with one or more differences between the uplink and downlink communications.

In some examples of the method, apparatuses, and non-transitory computer-readable medium described herein, receiving the first message may include operations, features, means, or instructions for receiving an indication of the multi-stage beamforming configuration, where, in accordance with the multi-stage beamforming configuration, the first stage may be associated with an entire reflective surface of the RIS and at least one of the one or more second stages may be associated with one or more subsets of the entire reflective surface of the RIS.

In some examples of the method, apparatuses, and non-transitory computer-readable medium described herein, each stage of the set of multiple stages may be associated with a respective phase granularity.

In some examples of the method, apparatuses, and non-transitory computer-readable medium described herein, each stage of the set of multiple stages may be associated with a respective codebook.

In some examples of the method, apparatuses, and non-transitory computer-readable medium described herein, receiving the second message indicating the beam training procedure may include operations, features, means, or instructions for receiving an indication to perform the beam training procedure for two or more stages of the set of multiple stages of the multi-stage beamforming configuration.

In some examples of the method, apparatuses, and non-transitory computer-readable medium described herein, receiving the second message indicating the beam training procedure may include operations, features, means, or instructions for receiving an indication of a set of RSs for the beam training procedure, the set of RSs associated with the at least one of the set of multiple stages.

In some examples of the method, apparatuses, and non-transitory computer-readable medium described herein, receiving the second message indicating the beam training procedure may include operations, features, means, or instructions for receiving an indication of a set of RSs for the beam training procedure and an indication of the at least one of the set of multiple stages.

In some examples of the method, apparatuses, and non-transitory computer-readable medium described herein, each stage of the set of multiple stages may be associated with a respective resource configuration for beam training procedures.

In some examples of the method, apparatuses, and non-transitory computer-readable medium described herein, RSs associated with the one or more second stages may have a lower periodicity than RSs associated with the first stage.

In some examples of the method, apparatuses, and non-transitory computer-readable medium described herein, a parameter reported for the beam training procedure may be based on the at least one of the set of multiple stages.

In some examples of the method, apparatuses, and non-transitory computer-readable medium described herein, receiving the second message indicating the beam training procedure may include operations, features, means, or instructions for receiving an indication of the at least one of the set of multiple stages and an indication of a content of a report for the beam training procedure, the content of the report based on the at least one of the set of multiple stages.

Some examples of the method, apparatuses, and non-transitory computer-readable medium described herein may further include operations, features, means, or instructions for receiving the first message indicating the set of multiple stages and receiving a third message indicating a respective content of a report for beam training procedures for each of the set of multiple stages.

In some examples of the method, apparatuses, and non-transitory computer-readable medium described herein, receiving the first message indicating the multi-stage beamforming configuration may include operations, features, means, or instructions for receiving an indication of the set of multiple stages and an indication of a respective content of a report for beam training procedures for each of the set of multiple stages.

Some examples of the method, apparatuses, and non-transitory computer-readable medium described herein may further include operations, features, means, or instructions for receiving an indication of a result of the beam training procedure for the at least one of the set of multiple stages based on the beam training procedure, where determining the one or more beamforming matrices may be based on receiving the indication of the result.

A method for wireless communication at a network entity is described. The method may include transmitting a first message indicating a multi-stage beamforming configuration for a RIS, the multi-stage beamforming configuration pertaining to a set of multiple stages that includes a first stage and one or more second stages that each refine one or more characteristics of the first stage and transmitting a second message indicating a beam training procedure for at least one of the set of multiple stages of the multi-stage beamforming configuration.

An apparatus for wireless communication at a network entity is described. The apparatus may include a processor, memory coupled with the processor, and instructions stored in the memory. The instructions may be executable by the processor to cause the apparatus to transmit a first message indicating a multi-stage beamforming configuration for a RIS, the multi-stage beamforming configuration pertaining to a set of multiple stages that includes a first stage and one or more second stages that each refine one or more characteristics of the first stage and transmit a second message indicating a beam training procedure for at least one of the set of multiple stages of the multi-stage beamforming configuration.

Another apparatus for wireless communication at a network entity is described. The apparatus may include means for transmitting a first message indicating a multi-stage beamforming configuration for a RIS, the multi-stage beamforming configuration pertaining to a set of multiple stages that includes a first stage and one or more second stages that each refine one or more characteristics of the first stage and means for transmitting a second message indicating a beam training procedure for at least one of the set of multiple stages of the multi-stage beamforming configuration.

A non-transitory computer-readable medium storing code for wireless communication at a network entity is described. The code may include instructions executable by a processor to transmit a first message indicating a multi-stage beamforming configuration for a RIS, the multi-stage beamforming configuration pertaining to a set of multiple stages that includes a first stage and one or more second stages that each refine one or more characteristics of the first stage and transmit a second message indicating a beam training procedure for at least one of the set of multiple stages of the multi-stage beamforming configuration.

In some examples of the method, apparatuses, and non-transitory computer-readable medium described herein, transmitting the first message may include operations, features, means, or instructions for transmitting an indication of the multi-stage beamforming configuration, where, in accordance with the multi-stage beamforming configuration, the first stage may be associated with one or more first channel characteristics and at least one of the one or more second stages may be associated with one or more second channel characteristics that may be of shorter duration than the one or more first channel characteristics.

In some examples of the method, apparatuses, and non-transitory computer-readable medium described herein, transmitting the first message may include operations, features, means, or instructions for transmitting an indication of the multi-stage beamforming configuration, where, in accordance with the multi-stage beamforming configuration, the first stage may be associated with a wideband frequency band and at least one of the one or more second stages may be associated with a narrowband frequency band that includes a subset of frequencies of the wideband frequency band.

In some examples of the method, apparatuses, and non-transitory computer-readable medium described herein, transmitting the first message may include operations, features, means, or instructions for transmitting an indication of the multi-stage beamforming configuration, where, in accordance with the multi-stage beamforming configuration, the first stage may be associated with a common beam for uplink and downlink communications and at least one of the one or more second stages may be associated with one or more differences between the uplink and downlink communications.

In some examples of the method, apparatuses, and non-transitory computer-readable medium described herein, transmitting the first message may include operations, features, means, or instructions for transmitting an indication of the multi-stage beamforming configuration, where, in accordance with the multi-stage beamforming configuration, the first stage may be associated with an entire reflective surface of the RIS and at least one of the one or more second stages may be associated with one or more subsets of the entire reflective surface of the RIS.

In some examples of the method, apparatuses, and non-transitory computer-readable medium described herein, each stage of the set of multiple stages may be associated with a respective phase granularity.

In some examples of the method, apparatuses, and non-transitory computer-readable medium described herein, each stage of the set of multiple stages may be associated with a respective codebook.

In some examples of the method, apparatuses, and non-transitory computer-readable medium described herein, transmitting the second message indicating the beam training procedure may include operations, features, means, or instructions for transmitting an indication to perform the beam training procedure for two or more stages of the set of multiple stages of the multi-stage beamforming configuration.

In some examples of the method, apparatuses, and non-transitory computer-readable medium described herein, transmitting the second message indicating the beam training procedure may include operations, features, means, or instructions for transmitting an indication of a set of RSs for the beam training procedure, the set of RSs associated with the at least one of the set of multiple stages.

In some examples of the method, apparatuses, and non-transitory computer-readable medium described herein, transmitting the second message indicating the beam training procedure may include operations, features, means, or instructions for transmitting an indication of a set of RSs for the beam training procedure and an indication of the at least one of the set of multiple stages.

In some examples of the method, apparatuses, and non-transitory computer-readable medium described herein, each stage of the set of multiple stages may be associated with a respective resource configuration for beam training procedures.

In some examples of the method, apparatuses, and non-transitory computer-readable medium described herein, RSs associated with the one or more second stages may have a lower periodicity than RSs associated with the first stage.

In some examples of the method, apparatuses, and non-transitory computer-readable medium described herein, a parameter reported for the beam training procedure may be based on the at least one of the set of multiple stages.

In some examples of the method, apparatuses, and non-transitory computer-readable medium described herein, transmitting the second message indicating the beam training procedure may include operations, features, means, or instructions for transmitting an indication of the at least one of the set of multiple stages and an indication of a content of a report for the beam training procedure, the content of the report based on the at least one of the set of multiple stages.

Some examples of the method, apparatuses, and non-transitory computer-readable medium described herein may further include operations, features, means, or instructions for transmitting the first message indicating the set of multiple stages and transmitting a third message indicating a respective content of a report for beam training procedures for each of the set of multiple stages.

In some examples of the method, apparatuses, and non-transitory computer-readable medium described herein, transmitting the first message indicating the multi-stage beamforming configuration may include operations, features, means, or instructions for transmitting an indication of the set of multiple stages and an indication of a respective content of a report for beam training procedures for each of the set of multiple stages.

Some examples of the method, apparatuses, and non-transitory computer-readable medium described herein may further include operations, features, means, or instructions for receiving an indication of a result of the beam training procedure for the at least one of the set of multiple stages based on performing the beam training procedure with the RIS and transmitting the indication of the result of the beam training procedure to a controller of the RIS.

A method for wireless communication at a UE is described. The method may include receiving, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage, receiving a second message indicating a beam training procedure for at least one of the set of multiple stages of the multi-stage beamforming configuration, and transmitting an indication of a result of the beam training procedure for the at least one of the set of multiple stages based on performing the beam training procedure with the RIS.

An apparatus for wireless communication at a UE is described. The apparatus may include a processor, memory coupled with the processor, and instructions stored in the memory. The instructions may be executable by the processor to cause the apparatus to receive, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage, receive a second message indicating a beam training procedure for at least one of the set of multiple stages of the multi-stage beamforming configuration, and transmit an indication of a result of the beam training procedure for the at least one of the set of multiple stages based on performing the beam training procedure with the RIS.

Another apparatus for wireless communication at a UE is described. The apparatus may include means for receiving, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage, means for receiving a second message indicating a beam training procedure for at least one of the set of multiple stages of the multi-stage beamforming configuration, and means for transmitting an indication of a result of the beam training procedure for the at least one of the set of multiple stages based on performing the beam training procedure with the RIS.

A non-transitory computer-readable medium storing code for wireless communication at a UE is described. The code may include instructions executable by a processor to receive, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage, receive a second message indicating a beam training procedure for at least one of the set of multiple stages of the multi-stage beamforming configuration, and transmit an indication of a result of the beam training procedure for the at least one of the set of multiple stages based on performing the beam training procedure with the RIS.

In some examples of the method, apparatuses, and non-transitory computer-readable medium described herein, receiving the second message indicating the beam training procedure may include operations, features, means, or instructions for receiving an indication to perform the beam training procedure for two or more stages of the set of multiple stages of the multi-stage beamforming configuration.

In some examples of the method, apparatuses, and non-transitory computer-readable medium described herein, receiving the second message indicating the beam training procedure may include operations, features, means, or instructions for receiving an indication of a set of RSs for the beam training procedure, the set of RSs associated with the at least one of the set of multiple stages.

In some examples of the method, apparatuses, and non-transitory computer-readable medium described herein, receiving the second message indicating the beam training procedure may include operations, features, means, or instructions for receiving an indication of a set of RSs for the beam training procedure and an indication of the at least one of the set of multiple stages.

In some examples of the method, apparatuses, and non-transitory computer-readable medium described herein, receiving the second message indicating the beam training procedure may include operations, features, means, or instructions for receiving an indication of the at least one of the set of multiple stages and an indication of a content of a report for the beam training procedure, the content of the report based on the at least one of the set of multiple stages.

Some examples of the method, apparatuses, and non-transitory computer-readable medium described herein may further include operations, features, means, or instructions for receiving the first message indicating the set of multiple stages and receiving a third message indicating a respective content of a report for beam training procedures for each of the set of multiple stages.

In some examples of the method, apparatuses, and non-transitory computer-readable medium described herein, receiving the first message indicating the multi-stage beamforming configuration may include operations, features, means, or instructions for receiving an indication of the set of multiple stages and an indication of a respective content of a report for beam training procedures for each of the set of multiple stages.

### BRIEF DESCRIPTION OF THE DRAWINGS

FIG. 1 illustrates an example of a wireless communications system that supports multiple stages of beamforming for reflective surfaces in accordance with one or more aspects of the present disclosure.

FIG. 2 illustrates an example of a wireless communications system that supports multiple stages of beamforming for reflective surfaces in accordance with one or more aspects of the present disclosure.

FIG. 3 illustrates an example of a reconfigurable intelligent surface (RIS) configuration that supports multiple stages of beamforming for reflective surfaces in accordance with one or more aspects of the present disclosure.

FIG. 4 illustrates an example of a process flow that supports multiple stages of beamforming for reflective surfaces in accordance with one or more aspects of the present disclosure.

FIGS. 5 and 6 show block diagrams of devices that support multiple stages of beamforming for reflective surfaces in accordance with one or more aspects of the present disclosure.

FIG. 7 shows a block diagram of a communications manager that supports multiple stages of beamforming for reflective surfaces in accordance with one or more aspects of the present disclosure.

FIG. 8 shows a diagram of a system including a device that supports multiple stages of beamforming for reflective surfaces in accordance with one or more aspects of the present disclosure.

FIGS. 9 and 10 show block diagrams of devices that support multiple stages of beamforming for reflective surfaces in accordance with one or more aspects of the present disclosure.

FIG. 11 shows a block diagram of a communications manager that supports multiple stages of beamforming for reflective surfaces in accordance with one or more aspects of the present disclosure.

FIG. 12 shows a diagram of a system including a device that supports multiple stages of beamforming for reflective surfaces in accordance with one or more aspects of the present disclosure.

FIGS. 13 and 14 show block diagrams of devices that support multiple stages of beamforming for reflective surfaces in accordance with one or more aspects of the present disclosure.

FIG. 15 shows a block diagram of a communications manager that supports multiple stages of beamforming for reflective surfaces in accordance with one or more aspects of the present disclosure.

FIG. 16 shows a diagram of a system including a device that supports multiple stages of beamforming for reflective surfaces in accordance with one or more aspects of the present disclosure.

FIGS. 17 through 20 show flowcharts illustrating methods that support multiple stages of beamforming for reflective surfaces in accordance with one or more aspects of the present disclosure.

### DETAILED DESCRIPTION

A network entity may, in some cases, employ a relaying device that uses passive components (e.g., capacitors, resistors) to reflect incoming signals in one or more directions. For example, the relaying device may be a reconfigurable intelligent surface (RIS), which may include or be coupled with a RIS controller. The RIS (e.g., a near passive device) may use a capacitor and a resistor to reflect a signal in a specific direction, where the reflection direction may be controlled by the network entity (e.g., via the RIS controller). For example, the RIS may redirect a signal from a user equipment (UE) to a network entity, or vice versa, by reflecting the signal around a blockage. As such, the RIS may increase cell coverage, spatial diversity, and beamforming gain (e.g., a RIS may use a relatively low power to redirect signals from a transmitting device to a receiving device). In some cases, the RIS may redirect signals using one or more weights (e.g., beamforming weights) applied to one or more elements of the RIS (e.g., as applied by the RIS controller). The weights, in the context of codebook-based beamforming, may be equivalently referred to as precoders.

In some cases, the RIS, the network entity, and/or the UE may use (e.g., select) a precoder for a beamformed communication based on one or more reference signals (RSs) communicated during a beam training procedure. For example, the network entity (e.g., for downlink communications) or the UE (e.g., for uplink communications) may sound the RIS with multiplexed RSs, which may then be reflected to a receiving device (e.g., the UE or the network entity, respectively). In such examples, the RIS may use a different codebook or non-codebook precoder for each RS occasion (e.g., training reference sequences), such that each RS occasion may be associated with a respective precoder. Configuring the RIS using an RS-based precoder selection may redirect transmissions, which may reduce blockages and otherwise increase communication quality. However, the redirected transmissions may be of a lower quality than direct communications between the UE and the network entity due to a limited granularity of the weights used by the RIS (e.g., one precoder per RS occasion).

The present disclosure provides techniques that support controller interfaces, protocols, or both, between the network entity and the RIS (e.g., via the RIS controller) to enhance adaptive control of the beamforming (e.g., reflection) direction between the network entity and the UE (e.g., via the RIS). For example, the network entity may configure the RIS with multiple stages (e.g., N stages) of beamforming to increase communication quality when redirecting communications via the RIS. In some cases, each stage may be a refinement of the prior stage (e.g., a summation of refinements), for up to N stages. For example, a first stage may indicate a set of channel characteristics while one or more other stages may further refine the channel (e.g. a first set of characteristics) with a second set of characteristics.

In some cases, the weights of each RIS element may be refined based on the respective location of the RIS element. In some examples, the first stage may be associated with a wideband frequency band (e.g., may carry a configuration for a frequency band combination) and one or more of the second stages may be associated with a respective narrowband frequency band that includes a subset of frequencies of the wideband frequency band (e.g., may be frequency band specific). In some examples, the first stage may be associated with a common beam for uplink and downlink communications, and one or more of the second stages may be associated with one or more differences between the uplink and downlink communications. In some other cases, the weights may be based on frequency bands or clusters of RIS elements, or both, where a cluster may be associated with serving a respective band. In some examples, the first stage may be associated with the entire RIS and one or more of the second stages may be associated with one or more subsets, respectively, of the RIS (e.g., subsets of elements of the RIS, a sub-RIS). Additionally or alternatively, the RIS elements of the RIS may have different weights on different frequency bands, or different clusters of RISs (e.g., a sub-RIS) may have different weights based on the band served by the respective cluster.

A network entity may configure a RIS controller and a UE with a multi-stage beamforming configuration for an associated RIS, where the multi-stage beamforming configuration may be associated with multiple stages that include a first stage and one or more second stages (e.g., that refine one or more characteristics of the first stage). The network entity may also transmit a message (e.g., to the RIS controller and the UE) indicating a beam training procedure for one or more of the multiple stages, where the beam training procedure includes communicating RSs between the network entity and the UE, via the RIS. Based on the configuration and the indication of the beam training procedure, the RIS controller may configure the RIS with element weights corresponding to the one or more stages associated with the beam training procedure. The network entity and the UE may perform the beam training procedure (e.g., communicate RSs via the RIS), and based on a result of the beam training procedure the RIS controller may configure one or more beamforming matrices for the RIS, for the one or more stages associated with the beam training procedure.

Aspects of the disclosure are initially described in the context of wireless communications systems. Aspects are then described with reference to a RIS configuration and a process flow. Aspects of the disclosure are further illustrated by and described with reference to apparatus diagrams, system diagrams, and flowcharts that relate to multiple stages of beamforming for reflective surfaces.

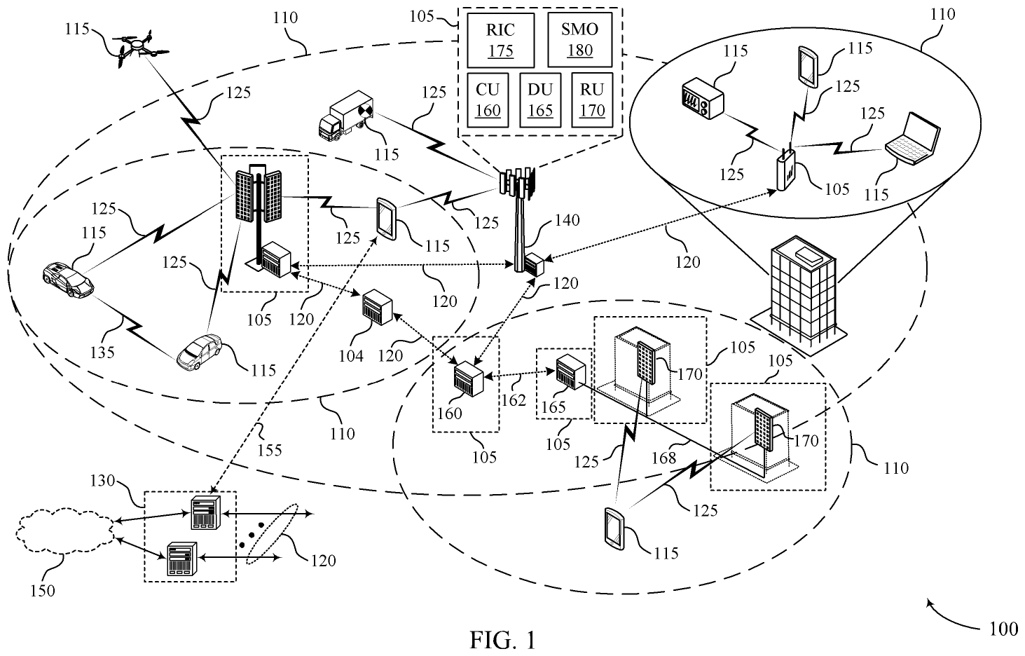

FIG. 1 illustrates an example of a wireless communications system 100 that supports multiple stages of beamforming for reflective surfaces in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support multiple stages of beamforming for reflective surfaces as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and Ns may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A network entity 105 may configure a RIS controller and a UE 115 with a multi-stage beamforming configuration for an associated RIS, where the multi-stage beamforming configuration may be associated with multiple stages that include a first stage and one or more second stages (e.g., that refine one or more characteristics of the first stage). The network entity 105 may also transmit a message (e.g., to the RIS controller and the UE 115) indicating a beam training procedure for one or more of the multiple stages, where the beam training procedure may include communicating RSs between the network entity 105 and the UE 115, via the RIS. Based on the configuration and the indication of the beam training procedure, the RIS controller may configure the RIS with element weights corresponding to the one or more stages associated with the beam training procedure. The network entity 105 and the UE 115 may perform the beam training procedure (e.g., communicate RSs via the RIS), and based on a result of the beam training procedure the RIS controller may configure one or more beamforming matrices for the RIS, for the one or more stages associated with the beam training procedure.

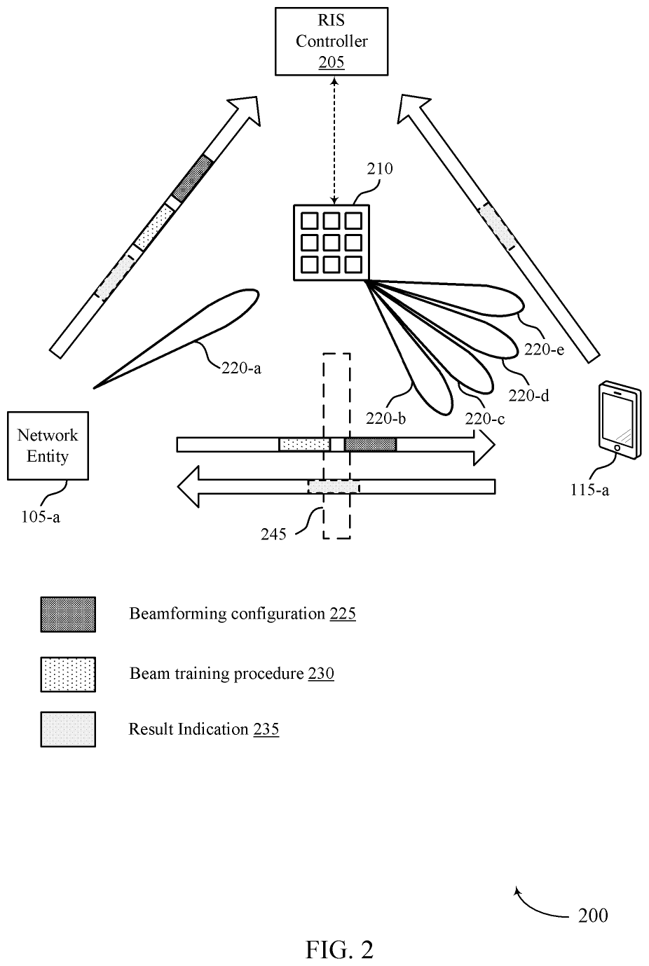

FIG. 2 illustrates an example of a wireless communications system 200 that supports multiple stages of beamforming for reflective surfaces in accordance with one or more aspects of the present disclosure. The wireless communications system 200 may include a network entity 105-a, a RIS controller 205, a RIS 210, and UE 115-a, which may be respective examples of the network entities 105, the RIS controllers, the RISs, and the UEs 115 as described with reference to FIG. 1. The RIS controller 205 may be coupled with the RIS 210, such that the RIS controller 205 may configure one or more aspects of the RIS 210.

The network entity 105-a may serve one or more UEs 115 (e.g., including the UE 115-a). In some examples, the network entity 105-a may transmit information to the UE 115-a using beamformed communications (e.g., messages sent using beams 220). In some examples, physical proximity, environmental factors (e.g., interference from other devices, blockages due to obstructions, or the like), or power constraints may impair beamformed communications between the network entity 105-a and the UE 115-a. In some examples, the network entity 105-a may be unable to transmit information directly to the UE 115-a via a line of sight (LOS) path, for example, due to interference from one or more other devices, due to a power constraint at network entity 105-a, due to a blockage 245 (e.g., an obstruction such as a building, tree, vehicle, mountain, or the like), due to a physical distance between the network entity 105-a and the UE 115-a, or due to any other factors affecting signal quality between the network entity 105-a and the UE 115-a.

To overcome such impairments, the network entity 105-a may employ a massive MIMO configuration (e.g., 5G massive MIMO) to increase throughput, as well as to affect one or more other communication parameters. In some examples, the massive MIMO configuration may use an active antenna unit (AAU) at the network entity 105-a for communications with the UE 115-a. The AAU may include one or more antenna ports with corresponding radio frequency (RF) chains (e.g., an individual RF chain per antenna port), and power amplifiers. The AAU may support increased spatial diversity, beamforming gain, cell coverage, and throughput at the network entity 105-a (e.g., resulting in a high beamforming gain). As such, in comparison to some other techniques, the UE 115-a may have a higher likelihood of successfully receiving the beamformed communication via the AAU. However, active components (e.g., RF chains, power amplifiers) used by the AAU may be associated with increased power consumption. For example, a power amplifier at the AAU may utilize significant power overhead to amplify and transmit a signal. Such power overhead may be undesirable and inefficient in some systems.

In some examples, the network entity 105-a may employ a relaying device that uses passive components (e.g., capacitors, resistors) to reflect incoming signals in one or more directions with a reduced power overhead. For example, the relaying device may be a RIS 210, which may include or be coupled with a RIS controller 205. For example, the RIS 210 (e.g., a near passive device) may use a capacitor and a resistor to reflect a signal in a specific direction, where the reflection direction may be controlled by the network entity 105-a (e.g., via the RIS controller 205). As such, the RIS may increase cell coverage, spatial diversity, and beamforming gain while consuming less power than an AAU. For example, a RIS may use a relatively low power to redirect signals from a transmitting device to a receiving device. In some cases, the RIS 210 may reflect or refract an impinging wave to a desired direction. For example, the RIS 210 may redirect a signal from the UE 115-a to the network entity 105-a, or vice versa, by reflecting the signal around a blockage 245.

In some cases, the RIS 210 may redirect signals using one or more weights (e.g., beamforming weights) applied to one or more elements of the RIS 210. For example, the RIS 210 may use the elements to redirect signals and the RIS 210 may redirect the signals using particular weights applied to the elements. The weights may be phase shifters, magnitude shifters, or panel angle shifters, among other weights associated with redirecting wireless signals. In some cases, the RIS 210 may generate or use a codebook with the one or more weights and may reference the codebook when redirecting wireless signals. The weights, in the context of codebook-based beamforming, may be equivalently referred to as precoders.

In some cases, the RIS 210, the network entity 105-a, and the UE 115-a may use (e.g., select) a precoder for a beamformed communication based on one or more RSs communicated during a beam training procedure. For example, the network entity 105-a (e.g., for downlink communications) or the UE 115-a (e.g., for uplink communications) may sound the RIS 210 with multiplexed RSs, which may then be reflected to a receiving device (e.g., the UE 115-a or the network entity 105-a, respectively). In the case of downlink RS sounding, the UE 115-a may transmit an index representing a respective RS index (e.g., an RS successfully received by the UE 115-a, an RS with a highest signal quality). In some examples, the RIS controller 205, the network entity 105-a, and/or the UE 115-a may select a precoder (e.g., downlink precoder) based on the indicated index. In such examples, the RIS 210 may use a different codebook or non-codebook precoder for each RS occasion (e.g., training reference sequences), such that each RS occasion may be associated with a respective precoder, which may be indicative of a precoder to use based on an indicated RS. Configuring the RIS 210 using an RS-based precoder selection may redirect transmissions, which may reduce blockages and otherwise increase communication quality. However, the redirected transmissions may be of a lower quality than direct communications between the UE 115-a and the network entity 105-a due to a limited granularity of the weights used by the RIS 210 (e.g., one precoder per RS occasion).

The present disclosure provides techniques that support controller interfaces, protocols, or both, between the network entity 105-a and the RIS 210 (e.g., via the RIS controller 205) to enhance adaptive control of the beamforming (e.g., reflection) direction to the UE 115-a. For example, the network entity 105-a may configure the RIS with multiple stages (e.g., N stages, as represented by Φ₁ to Φ_{N}) of beamforming to increase communication quality when redirecting communications via the RIS 210 (e.g., similar to beam matrix W1 W2 design in type 1 and type 2 channel state feedback (CSF)). For example, the beamformer for the RIS 210 may be represented as ¢=Φ₁ Φ₂ Φ₃ . . . . Φ_{N}, with N stages of beamforming, where each stage may be a diagonal matrix having a size of L×L (e.g., for a RIS 210 with L elements).

In some cases, each stage may be a refinement of the prior stage (e.g., a summation of refinements), for up to N stages. For example, in CSF, as W1 may carry wideband beams (e.g., a same beam across multiple sub-bands), while W2 may carry per sub-band precoders, a first stage Φ₁ may indicate a set of channel characteristics while other stages (e.g., one or more of Φ₂ to Φ_{N}) may further refine the channel (e.g. the first set of characteristics) with a second set of characteristics. As opposed to CSF, the N stages of beamforming may include changing physical weights of the RIS elements based on element location, frequency band, or cluster of elements (e.g., where a cluster is associated with a frequency band). Similarly, as opposed to CSF, beam training may be done at different times, such that the different stages (e.g., different Φ) may be taken care of at different times (e.g., determine a Φ₁ first, and take care of short-term changes using other Φ values). Multiplication of two phases may be represented as exp(−jϕ₁)*exp(−jϕ₂), which may be equivalent to exp(−j(ϕ₁+ϕ₂)) (e.g., where a first stage is represented by ϕ₁ and a second stage is represented by ϕ₂).

In some cases, the weights of each RIS element may be refined based on the respective location of the RIS element. In some examples, the characteristics of the one or more second stages may be of a shorter duration than the characteristics of the first state. For example, Φ₁ may indicate long-term channel changes or characteristics, while other stages (e.g., one or more of Φ₂ to Φ_{N}) may indicate short-term channel changes or characteristics (e.g., the fine tuning of weights on some or all of the RIS elements).

In some examples, the first stage may be associated with a wideband frequency band (e.g., may carry a configuration for a frequency band combination) and one or more of the second stages may be associated with a respective narrowband frequency band that includes a subset of frequencies of the wideband frequency band (e.g., may be frequency band specific). For example, the first stage Φ₁ may indicate a wide-angle beam while other stage(s) may carry narrower beams to more refined locations. In some cases, such as in FDD modes (e.g., where the uplink and downlink channels are correlated with one another), the uplink and downlink channels may both use Φ₁ while Φ₂ may distinguish between each band. As an illustrative example, the first stage could configure a wideband beam for multiple UE's 115 (e.g., the UE 115-a and one or more other UEs 115), and a second stage could configure a narrow beam specific to one of the multiple UEs (e.g., for the UE 115-a, or one of the other UEs 115).

In some examples, the first stage may be associated with a common beam for uplink and downlink communications, and one or more of the second stages may be associated with one or more differences between the uplink and downlink communications. For example, the first stage Φ₁ may indicate a common beam for uplink and downlink while other stages may indicate a change (e.g., delta) to carry the differences between the uplink and downlink channels, for example, due to RF changes between the receiving and transmitting RF of each device.

In some other cases, the weights may be based on frequency bands or clusters of RIS elements, or both, where a cluster may be associated with serving a respective band. In some examples, the first stage may be associated with the entire RIS 210 and one or more of the second stages may be associated with one or more subsets, respectively, of the RIS 210 (e.g., subsets of elements of the RIS 210, sub-RIS). For example, Φ₁ may be a frequency independent stage while another one or more stages may be frequency dependent. Additionally or alternatively, the RIS elements of the RIS 210 may have different weights (e.g., associated with one of Φ₂ to Φ_{N}) on different frequency bands, or different clusters of RISs (e.g., a sub-RIS) may have different weights based on the band served by the respective cluster. In such examples, while training the RIS 210 (e.g., obtaining Φ₁) the RIS 210 may be training across all sub-RIS (e.g., all element clusters) and each sub-RIS may be controlled by a respective beamforming stage. As an illustrative example, when multiple sub-RISs are serving the same UE 115 or a set of UEs 115 in the same area (on the same or different subbands), a stage Φ_{y} may be associated to train a sub-RIS X and to carry changes observed for that sub-RIS.

The network entity 105-a may perform a beam training procedure with the RIS 210 and the UE 115-a, which may be supported by the RIS controller 205 (e.g., which may configure the RIS 210). In such cases, the network entity 105-a may configure the RIS controller 205 and the UE 115-a to support N stages for a beam training procedure. The network entity 105-a may transmit a first message (e.g., beamforming configuration 225) to the RIS controller 205 and to the UE 115-a (e.g., via the RIS 210). For example, the first message may indicate a multi-stage beamforming configuration 225 for the RIS 210 (e.g., as configured by the RIS controller 205) and the UE 115-a. In some cases, the multi-stage beamforming configuration 225 may be associated with multiple stages (e.g., a first stage, Φ₁, and one or more second stages, Φ₂ to Φ_{N}, where the second stage(s) may refine one or more characteristics of the first stage).

The network entity 105-a may transmit a second message (e.g., an indication of a beam training procedure 230) to the RIS controller 205 and the UE 115-a. The network entity 105-a may transmit the second message to the RIS controller 205 and to the UE 115-a (e.g., via the RIS 210). For example, the second message may indicate a beam training procedure for at least one of the multiple stages indicated by the multi-stage beamforming configuration 225. In some cases, the second message may trigger performance of the beam training procedure for two or more stages of the multiple stages. For example, the second message may trigger the RIS controller 205 to train one stage (e.g., either Φ₁, Φ₂, or another stage), or multiple stages (e.g., Φ₂ and Φ₃, or some other combination of stages) for a combination of stages to be trained at a same time.

In some examples, the second message may indicate a set of RSs associated with at least one of the multiple stages. For example, the network entity 105-a may transmit a sequence of RSs towards the RIS 210, which may trigger the RIS 210 to redirect the RSs to a receiving device, such as the UE 115-a. In such cases, the network entity 105-a may transmit a sequence of RSs toward the RIS 210 (e.g., via beam 220-a) and the RIS 210 may redirect one or more of the RSs to UE 115-a (e.g., via one or more of the beams 220-b, 220-c, 220-d, 220-e, or some combination thereof) based on the associated stage(s) being trained.

In some cases, if a first RS set is used to train Φ₁, and a second RS set is used to train Φ₂ (e.g., each RS set is associated with a respective stage) the RIS controller 205 may sweep Φ₂ when the second RS set is triggered or received (e.g., the RIS controller 205 may configure the RIS 210 for a beamforming stage based on the indicated RS set). In some cases, each stage may be associated with a respective resource configuration for beam training procedures. For example, each training stage may have a different resource configuration to reduce resource overhead, reporting overhead (e.g., from the UE 115), or both.

In some examples, the RSs associated with each stage may be associated with a respective periodicity. For example, RSs for the one or more second stages (e.g., Φ₂ to Φ_{N}) may have a lower periodicity than RSs associated with the first stage (e.g., Φ₁), such as based on a relevant time frame for the associated stage (e.g., Φ₂ to Φ_{N} may be associated with more fast or short-term changes). For example, the one or more second stages may be associated with training RSs that are periodic or semi-persistent. Likewise, the first stage may be associated with training RSs that are aperiodic or less frequent. In such examples, the periodicity of the second stages may be higher than the periodicity of the first stage, such that the RSs associated with the second stages occur more frequently than those of the first stage.

In some cases, the second message may indicate a set of RSs and a stage for the beam training procedure (e.g., if a respective set of RSs is not associated with a corresponding stage). Additionally or alternatively, for a per-report configuration, there may be a parameterization of the corresponding beam training. In such examples, the RIS controller 205 may be triggered by signaling (e.g., a report configuration ID indicated in the beamforming configuration 225) to identify which stage to optimize using the corresponding codebook (e.g., or set of weights). For example, in some cases, the second message may indicate at least one stage of the multiple stages as well as a configuration of a report content (e.g., report configuration ID) for the beam training procedure, where the configuration of the report content may be based in part on the one or more indicated stages. In such cases, the configuration may include a CSI-RS configuration, a report configuration, stage information, an indication of the multiple stages, or other configuration information.

In some cases, the first message may indicate the multiple beamforming stages, and one or more following messages may indicate (e.g., an explicit indication) a respective content for a report for a corresponding stage, for each of the multiple stages. In such cases, the configuration may include a CSI-RS configuration and a report configuration, among other configuration information. In some examples, the report configuration (e.g., reportConfigID) may include previous RRC configuration or MAC control element (MAC-CE) configuration information that includes information about the report for a given stage. In some cases, the first message may indicate the multiple beamforming stages and a respective content for a report for each of the multiple stages. In such cases, the configuration may include a CSI-RS configuration, a report configuration (e.g., base report configuration), a report configuration for respective stages, stage information, an indication of the multiple stages, or other configuration information.

The UE 115-a may measure the RSs (e.g., redirected from the RIS 210) and may determine a result of the beam training procedure (e.g., one or more RS measurements, a beam or RS). For example, in some cases, based on the capabilities of the UE 115-a, the UE 115-a may measure the change (e.g., delta) required to calibrate an RF between uplink and downlink (e.g., under TDD or FDD, over different sub-bands within a system). In some examples, the UE 115-a may measure and indicate the result of at least one stage to the RIS controller 205 via a third message (e.g., a result indication 235). Additionally or alternatively, the UE 115-a may transmit the third message to the network entity 105-a (e.g., via the RIS 210), and the network entity may transmit a result indication 235 to the RIS controller 205.

In some cases, the UE 115-a may indicate a result for one stage (e.g., $1 or another stage, such as one of Φ₂ to Φ_{N}) or for multiple stages (e.g., any two or more stages within Φ₁ to Φ_{N}). In some cases, the RIS controller 205 may reconfigure the RIS 210 based on the result reported by the UE 115-a. For example, the RIS controller 205 may determine one or more beamforming matrices for at least one stage based on the result indicated by the UE 115-a (e.g., a matrix of Φ₂ or a vector of Φ₂, such as based on a sub-band parameter). In such examples, the RIS controller 205 may apply the beamforming matrices to the RIS 210 for further communications between the network entity 105-a and the UE 115-a.

In some cases, a report for the beam training procedure may change based on beamforming stage. For example, based on the codebook design and the accuracy associated with the beams, the number of reported beams per stage (e.g., a number of the highest quality beams, the lowest quality beams, or both) could change. For example, a report may be configured to indicate a resource index of K number of high quality beams for the first stage and Y number of high quality beams for the second stage (e.g., for one or more stages other than the first stage). The number of beams associated with each stage, the indexing, or both may be added to the report configuration. Once the report configuration is triggered, and the stage is determined, the number of beams associated with the stage may be determined by the UE 115-a, the RIS controller 205, or both. In some cases, soft information (e.g., RSRP, RSRQ, SINR, SPEF, or some combination thereof) may be reported during beam training for one or more stages. For example, soft information may be sent (e.g., reported) while obtaining stages Φ₂ and Φ₃ (e.g., among other possible stages), while soft information may not be sent while obtaining stage Φ₁. The transmission of soft information may be based on a report configuration (e.g., reportConfigID).

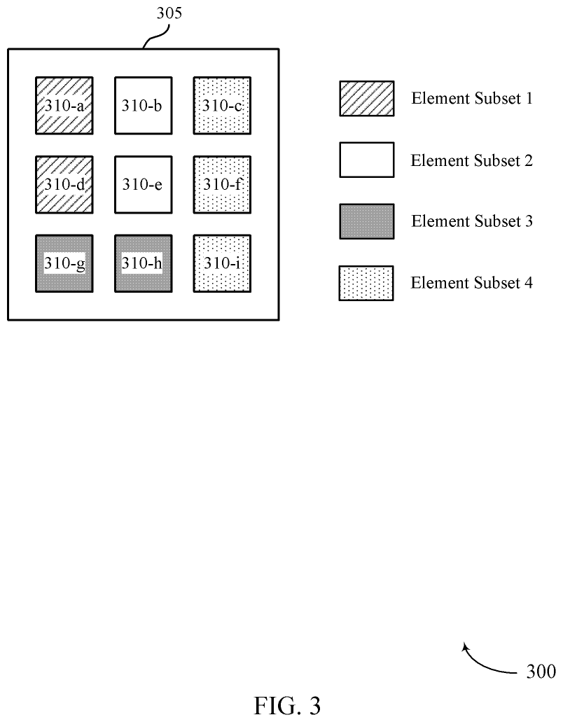

FIG. 3 illustrates an example of a RIS configuration 300 that supports multiple stages of beamforming for reflective surfaces in accordance with one or more aspects of the present disclosure. The RIS configuration 300 may include a RIS 305, which may include multiple RIS elements (e.g., antennas or patch antennas). The RIS 305 may be used for communications between one or more network entities 105, and/or one or more UEs 115, which may be examples of network entities 105 and UEs 115 as described with reference to FIGS. 1 and 2. Additionally, the RIS 305 may be controlled by a RIS controller, which may be an example of a RIS controller as described with reference to FIGS. 1 and 2. In some cases, the RIS controller may configure the RIS 305 with the RIS configuration 300 (e.g., as described with reference to FIG. 2).

In some cases, a set of reference signals may be configured for beam training communications between a network entity 105 and a UE 115, via a RIS 305. In such cases, each stage may be associated with a phase granularity. For example, a first stage, ϕ₁, may be associated with all RIS elements 310 of the RIS 305 (e.g., elements 310-a through 310-i). In contrast, ϕ₂ may be associated with a more refined grouping of RIS elements. For example, ϕ₂ may only impact the characteristics (e.g., weights, coefficients) of the elements in element subset 1 (e.g., elements 310-a and 310-d, a first sub-RIS). In some cases, ϕ₂ or one or more other stages, may be associated with other groupings, such as one or more of element subset 2 (e.g., elements 310-b and 310-e), element subset 3 (e.g., elements 310-g and 310-h), element subset 4 (e.g., elements 310-c, 310-f, and 310-i), or some other set of RIS elements 310.

In some cases, each stage may be associated with a respective codebook. For example, ϕ₁ may be a codebook-based beamformer (e.g., discrete fourier transform (DFT) beamformer) and ϕ₂ may be non-codebook based. In such examples, ϕ₂ may have more phase granularity in order to achieve finer phases. In some cases, the additional stages, or second stages, may be used to obtain updated weights of their associated RIS elements 310. The codebook or non-codebook configuration associated with a respective stage, or the phase granularity associated with a respective stage, may in some cases be based on an assumption that a same set of RSs are configured for training multiple devices (e.g., a first device and a second device) via the RIS 305.

In some cases, the RIS may be split into clusters (e.g. sub-RIS, element subsets), where each cluster may include a set of one or more RIS elements 310. For example, in some cases, each element subset may be a cluster associated with one or more RIS elements 310. In such cases, the one or more additional stages, or second stages, may be used to obtain updated weights on associated clusters (e.g., RIS elements 310). For example, a first stage may be associated with the complete RIS (e.g., all clusters and all antennas), and a second stage may be associated with one or more RIS clusters (e.g., element subset 1, element subset 2, element subset 3, element subset 4, or some combination thereof). In some examples, the RIS elements 310 may be grouped into different RIS clusters, or some RIS elements 310 may overlap between different RIS clusters.

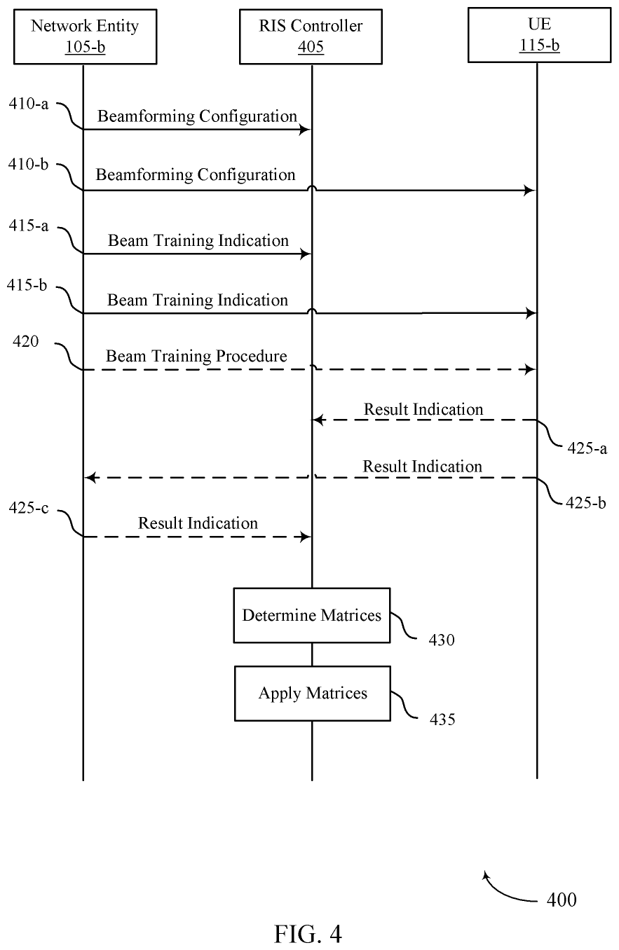

FIG. 4 illustrates an example of a process flow 400 that supports multiple stages of beamforming for reflective surfaces in accordance with one or more aspects of the present disclosure. The process flow 400 may implement or be implemented by aspects of the wireless communications system 100, the wireless communications system 200, or the RIS configuration 300. For example, process flow 400 may be implemented by a UE 115-b, a RIS controller 405, and a network entity 105-b, which may be examples of a UE 115, a RIS controller, and a network entity 105 described with reference to FIGS. 1-3.

In the following description of process flow 400, the operations may be performed in a different order than the order shown, or the operations performed by UE 115-b, RIS controller 405, and network entity 105-b may be performed in different orders or at different times. For example, some operations may also be left out of process flow 400, or other operations may be added to process flow 400. Although UE 115-b, RIS controller 405, and network entity 105-b are shown performing the operations of process flow 400, some aspects of some operations may also be performed by one or more other wireless devices. For example, some actions shown as being performed by network entity 105-b may be performed by the RIS controller, or vice versa. Communications between the network entity 105-b and the UE 115-b may be via a RIS as described herein.

At 410-a, the network entity 105-b may transmit a beamforming configuration to the RIS controller 405. For example, the beamforming configuration may be a multi-stage beamforming configuration for the RIS. In some examples, the beamforming configuration may be associated with multiple stages (e.g., a first stage and one or more other stages). In some cases, the one or more second stages may include characteristics which refine the characteristics of the first stage. For example, the first stage may configure a wideangle beam, and a second stage may configure a narrow beam for a more refined direction, among other examples. The beamforming configuration may include other information and/or indications, for example, as described with reference to FIG. 2. At 410-b, the network entity 105-b may also transmit the beamforming configuration to the UE 115-b (e.g., via the RIS).

At 415-a, the network entity 105-b may transmit an indication of a beam training procedure to the RIS controller 405. The beam training procedure may be associated with at least one stage of the multiple stages. For example, the beam training procedure may trigger the beam training associated with a first stage or another stage. In some examples, the beam training procedure may be associated with two or more stages of the multiple stages. For example, the beam training procedure may trigger the beam training associated with any combination of stages, such as a second stage and a third stage (e.g., among other examples). In some cases, the indication of the beam training procedure may indicate of a set of reference signals for the beam training procedure, the set of reference signals associated with the at least one stage. Alternatively, the indication may indicate both a set of reference signals for the beam training procedure and the stages associated with the beam training procedure. The indication of the beam training procedure may include other information and/or indications, for example, as described with reference to FIG. 2. At 415-b, the network entity 105-b may also transmit the indication of the beam training procedure to the UE 115-b (e.g., via the RIS).

At 420, the network entity 105-b may perform the beam training procedure with the RIS and the UE 115-b. For example, the network entity 105-b may transmit, to the UE 115-b, one or more RSs associated with the at least one stage (e.g., as indicated in a configuration associated with the at least one stage), where the one or more RSs may be transmitted via the RS (e.g., as configured by the RIS controller 405 for the at least one stage). The UE 115-b may make one or more measurements and/or one or more determinations based on receiving the RS(s) via the RIS.

At 425-a, in some cases, the UE 115-b may transmit a result indication to the RIS controller 405 (e.g., based on the measurement(s) and/or determination(s)). For example, the result indication may include a result of the beam training procedure (e.g., highest quality beams, lowest quality beams, or some combination thereof). At 425-b, in some cases, the UE 115-b may transmit a result indication to the network entity 105-b. Additionally, in some cases at 425-c, the network entity 105-b may transmit the result indication to the RIS controller 405 (e.g., based on receiving the result indication from the UE 115-b). In some examples, the transmission may be a relayed transmission of the result indication from the UE 115-b. The result indication may include information described herein, for example, with reference to FIG. 2.

At 430, the RIS controller 405 may determine one or more beamforming matrices for the stages of the beam training procedure (e.g., in response to a result indication, as indicated or configured by the network entity 105-b in response to a result indication). For example, each stage may be a diagonal matrix associated with the number of elements (e.g., antennas) of the RIS. At 435, the RIS controller 405 may apply the one or more beamforming matrices to the surface of the RIS (e.g., configure the RIS elements) to relay communications by the network entity 105-b to the UE 115-b using the stage(s).

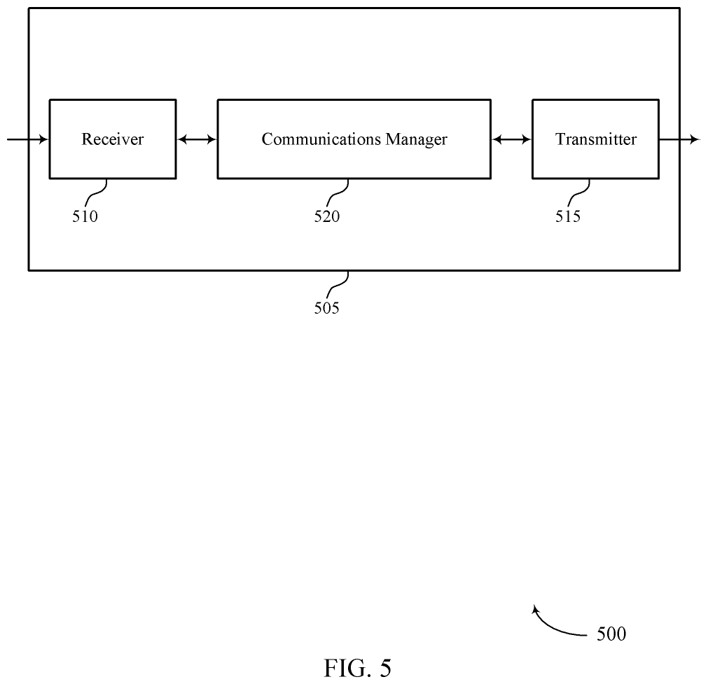

FIG. 5 shows a block diagram 500 of a device 505 that supports multiple stages of beamforming for reflective surfaces in accordance with one or more aspects of the present disclosure. The device 505 may be an example of aspects of a RIS controller as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to multiple stages of beamforming for reflective surfaces). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to multiple stages of beamforming for reflective surfaces). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of multiple stages of beamforming for reflective surfaces as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a controller of a RIS in accordance with examples as disclosed herein. For example, the communications manager 520 may be configured as or otherwise support a means for receiving, from a network entity, a first message indicating a multi-stage beamforming configuration for the RIS, the multi-stage beamforming configuration pertaining to a set of multiple stages that includes a first stage and one or more second stages that each refine one or more characteristics of the first stage. The communications manager 520 may be configured as or otherwise support a means for receiving a second message indicating a beam training procedure for at least one of the set of multiple stages of the multi-stage beamforming configuration. The communications manager 520 may be configured as or otherwise support a means for determining one or more beamforming matrices for the at least one of the set of multiple stages based on the beam training procedure. The communications manager 520 may be configured as or otherwise support a means for applying the one or more beamforming matrices to the RIS for communications by the network entity using the at least one of the set of multiple stages.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced power consumption and more efficient utilization of communication resources.

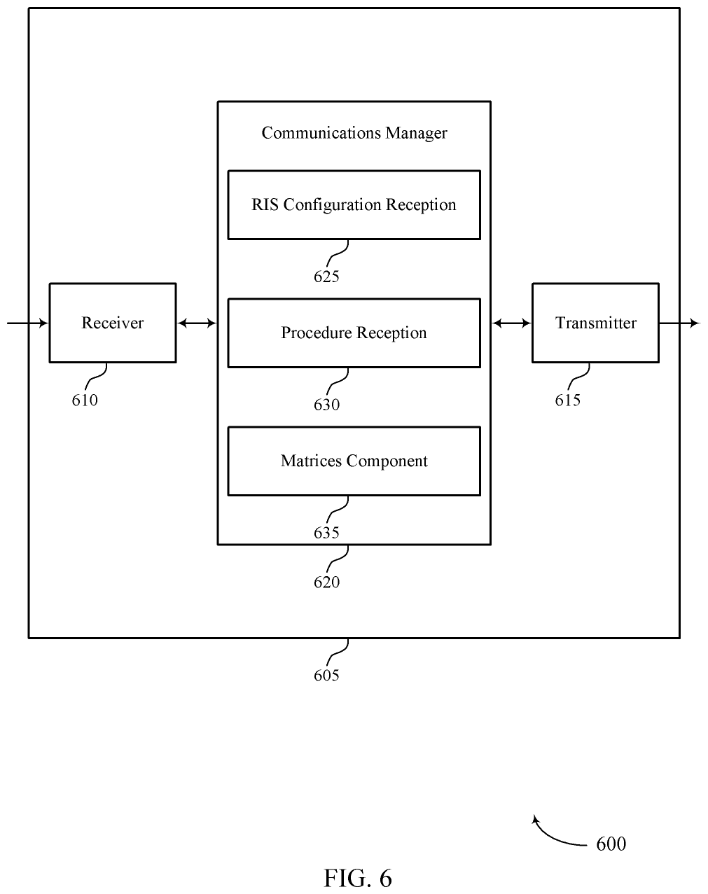

FIG. 6 shows a block diagram 600 of a device 605 that supports multiple stages of beamforming for reflective surfaces in accordance with one or more aspects of the present disclosure. The device 605 may be an example of aspects of a device 505 or a RIS controller as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to multiple stages of beamforming for reflective surfaces). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multiple stages of beamforming for reflective surfaces). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of multiple stages of beamforming for reflective surfaces as described herein. For example, the communications manager 620 may include a RIS configuration reception 625, a procedure reception 630, a matrices component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a controller of a RIS in accordance with examples as disclosed herein. The RIS configuration reception 625 may be configured as or otherwise support a means for receiving, from a network entity, a first message indicating a multi-stage beamforming configuration for the RIS, the multi-stage beamforming configuration pertaining to a set of multiple stages that includes a first stage and one or more second stages that each refine one or more characteristics of the first stage. The procedure reception 630 may be configured as or otherwise support a means for receiving a second message indicating a beam training procedure for at least one of the set of multiple stages of the multi-stage beamforming configuration. The matrices component 635 may be configured as or otherwise support a means for determining one or more beamforming matrices for the at least one of the set of multiple stages based on the beam training procedure. The matrices component 635 may be configured as or otherwise support a means for applying the one or more beamforming matrices to the RIS for communications by the network entity using the at least one of the set of multiple stages.

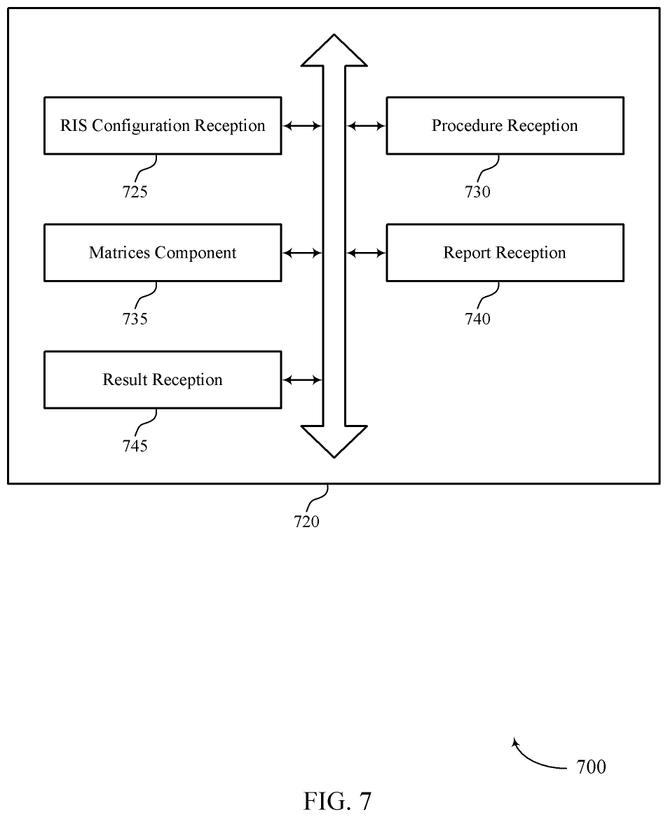

FIG. 7 shows a block diagram 700 of a communications manager 720 that supports multiple stages of beamforming for reflective surfaces in accordance with one or more aspects of the present disclosure. The communications manager 720 may be an example of aspects of a communications manager 520, a communications manager 620, or both, as described herein. The communications manager 720, or various components thereof, may be an example of means for performing various aspects of multiple stages of beamforming for reflective surfaces as described herein. For example, the communications manager 720 may include a RIS configuration reception 725, a procedure reception 730, a matrices component 735, a report reception 740, a result reception 745, or any combination thereof. Each of these components may communicate, directly or indirectly, with one another (e.g., via one or more buses).

The communications manager 720 may support wireless communication at a controller of a RIS in accordance with examples as disclosed herein. The RIS configuration reception 725 may be configured as or otherwise support a means for receiving, from a network entity, a first message indicating a multi-stage beamforming configuration for the RIS, the multi-stage beamforming configuration pertaining to a set of multiple stages that includes a first stage and one or more second stages that each refine one or more characteristics of the first stage. The procedure reception 730 may be configured as or otherwise support a means for receiving a second message indicating a beam training procedure for at least one of the set of multiple stages of the multi-stage beamforming configuration. The matrices component 735 may be configured as or otherwise support a means for determining one or more beamforming matrices for the at least one of the set of multiple stages based on the beam training procedure. In some examples, the matrices component 735 may be configured as or otherwise support a means for applying the one or more beamforming matrices to the RIS for communications by the network entity using the at least one of the set of multiple stages.

In some examples, to support receiving the first message, the RIS configuration reception 725 may be configured as or otherwise support a means for receiving an indication of the multi-stage beamforming configuration, where, in accordance with the multi-stage beamforming configuration, the first stage is associated with one or more first channel characteristics and at least one of the one or more second stages is associated with one or more second channel characteristics that are of shorter duration than the one or more first channel characteristics.

In some examples, to support receiving the first message, the RIS configuration reception 725 may be configured as or otherwise support a means for receiving an indication of the multi-stage beamforming configuration, where, in accordance with the multi-stage beamforming configuration, the first stage is associated with a wideband frequency band and at least one of the one or more second stages is associated with a narrowband frequency band that includes a subset of frequencies of the wideband frequency band.

In some examples, to support receiving the first message, the RIS configuration reception 725 may be configured as or otherwise support a means for receiving an indication of the multi-stage beamforming configuration, where, in accordance with the multi-stage beamforming configuration, the first stage is associated with a common beam for uplink and downlink communications and at least one of the one or more second stages is associated with one or more differences between the uplink and downlink communications.

In some examples, to support receiving the first message, the RIS configuration reception 725 may be configured as or otherwise support a means for receiving an indication of the multi-stage beamforming configuration, where, in accordance with the multi-stage beamforming configuration, the first stage is associated with an entire reflective surface of the RIS and at least one of the one or more second stages is associated with one or more subsets of the entire reflective surface of the RIS.

In some examples, each stage of the set of multiple stages is associated with a respective phase granularity.

In some examples, each stage of the set of multiple stages is associated with a respective codebook.

In some examples, to support receiving the second message indicating the beam training procedure, the procedure reception 730 may be configured as or otherwise support a means for receiving an indication to perform the beam training procedure for two or more stages of the set of multiple stages of the multi-stage beamforming configuration.

In some examples, to support receiving the second message indicating the beam training procedure, the procedure reception 730 may be configured as or otherwise support a means for receiving an indication of a set of RSs for the beam training procedure, the set of RSs associated with the at least one of the set of multiple stages.

In some examples, to support receiving the second message indicating the beam training procedure, the procedure reception 730 may be configured as or otherwise support a means for receiving an indication of a set of RSs for the beam training procedure and an indication of the at least one of the set of multiple stages.

In some examples, each stage of the set of multiple stages is associated with a respective resource configuration for beam training procedures.

In some examples, RSs associated with the one or more second stages have a lower periodicity than RSs associated with the first stage.

In some examples, a parameter reported for the beam training procedure is based on the at least one of the set of multiple stages.

In some examples, to support receiving the second message indicating the beam training procedure, the procedure reception 730 may be configured as or otherwise support a means for receiving an indication of the at least one of the set of multiple stages and an indication of a content of a report for the beam training procedure, the content of the report based on the at least one of the set of multiple stages.

In some examples, the RIS configuration reception 725 may be configured as or otherwise support a means for receiving the first message indicating the set of multiple stages. In some examples, the report reception 740 may be configured as or otherwise support a means for receiving a third message indicating a respective content of a report for beam training procedures for each of the set of multiple stages.

In some examples, to support receiving the first message indicating the multi-stage beamforming configuration, the RIS configuration reception 725 may be configured as or otherwise support a means for receiving an indication of the set of multiple stages and an indication of a respective content of a report for beam training procedures for each of the set of multiple stages.

In some examples, the result reception 745 may be configured as or otherwise support a means for receiving an indication of a result of the beam training procedure for the at least one of the set of multiple stages based on the beam training procedure, where determining the one or more beamforming matrices is based on receiving the indication of the result.

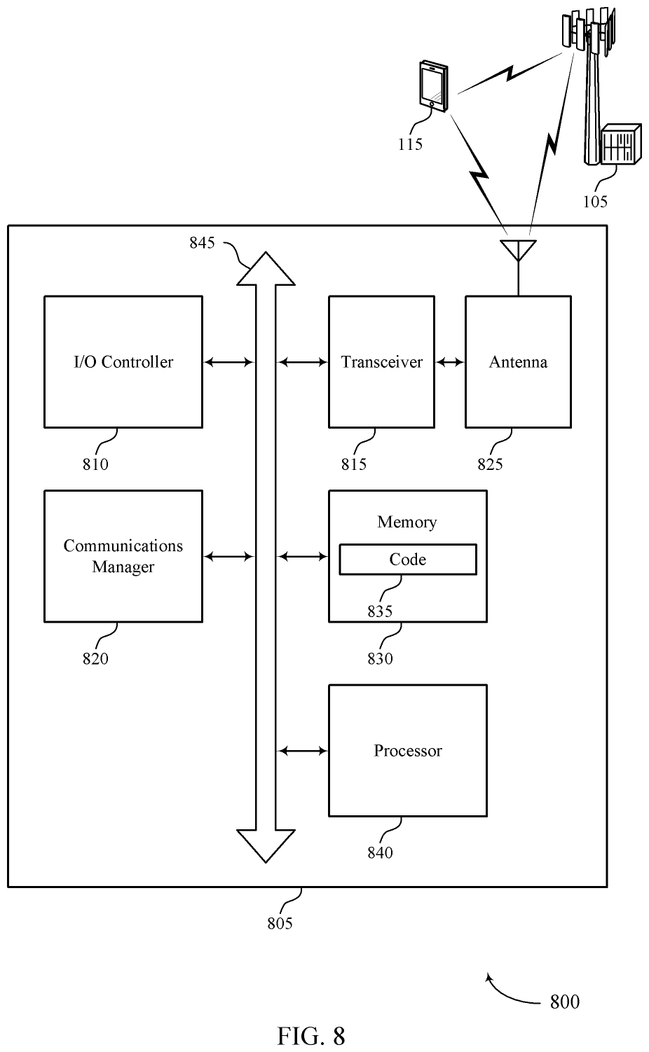

FIG. 8 shows a diagram of a system 800 including a device 805 that supports multiple stages of beamforming for reflective surfaces in accordance with one or more aspects of the present disclosure. The device 805 may be an example of or include the components of a device 505, a device 605, or a RIS controller as described herein. The device 805 may include components for bi-directional voice and data communications including components for transmitting and receiving communications, such as a communications manager 820, an I/O controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include RAM and ROM. The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a BIOS which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting multiple stages of beamforming for reflective surfaces). For example, the device 805 or a component of the device 805 may include a processor 840 and memory 830 coupled with or to the processor 840, the processor 840 and memory 830 configured to perform various functions described herein.

The communications manager 820 may support wireless communication at a controller of a RIS in accordance with examples as disclosed herein. For example, the communications manager 820 may be configured as or otherwise support a means for receiving, from a network entity, a first message indicating a multi-stage beamforming configuration for the RIS, the multi-stage beamforming configuration pertaining to a set of multiple stages that includes a first stage and one or more second stages that each refine one or more characteristics of the first stage. The communications manager 820 may be configured as or otherwise support a means for receiving a second message indicating a beam training procedure for at least one of the set of multiple stages of the multi-stage beamforming configuration. The communications manager 820 may be configured as or otherwise support a means for determining one or more beamforming matrices for the at least one of the set of multiple stages based on the beam training procedure. The communications manager 820 may be configured as or otherwise support a means for applying the one or more beamforming matrices to the RIS for communications by the network entity using the at least one of the set of multiple stages.

By including or configuring the communications manager 820 in accordance with examples as described herein, the device 805 may support techniques for improved communication reliability, reduced power consumption, more efficient utilization of communication resources, improved coordination between devices, longer battery life, and improved user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of multiple stages of beamforming for reflective surfaces as described herein, or the processor 840 and the memory 830 may be otherwise configured to perform or support such operations.

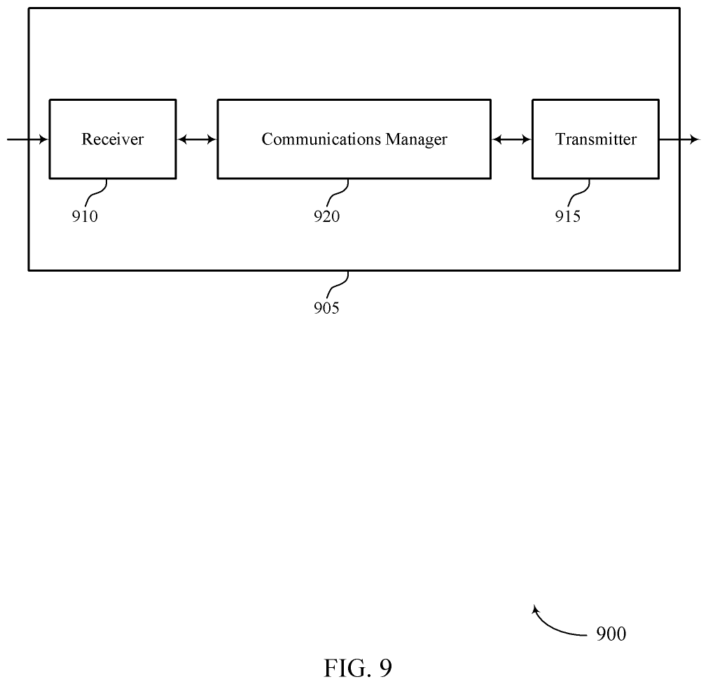

FIG. 9 shows a block diagram 900 of a device 905 that supports multiple stages of beamforming for reflective surfaces in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of multiple stages of beamforming for reflective surfaces as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting a first message indicating a multi-stage beamforming configuration for a RIS, the multi-stage beamforming configuration pertaining to a set of multiple stages that includes a first stage and one or more second stages that each refine one or more characteristics of the first stage. The communications manager 920 may be configured as or otherwise support a means for transmitting a second message indicating a beam training procedure for at least one of the set of multiple stages of the multi-stage beamforming configuration.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption and more efficient utilization of communication resources.

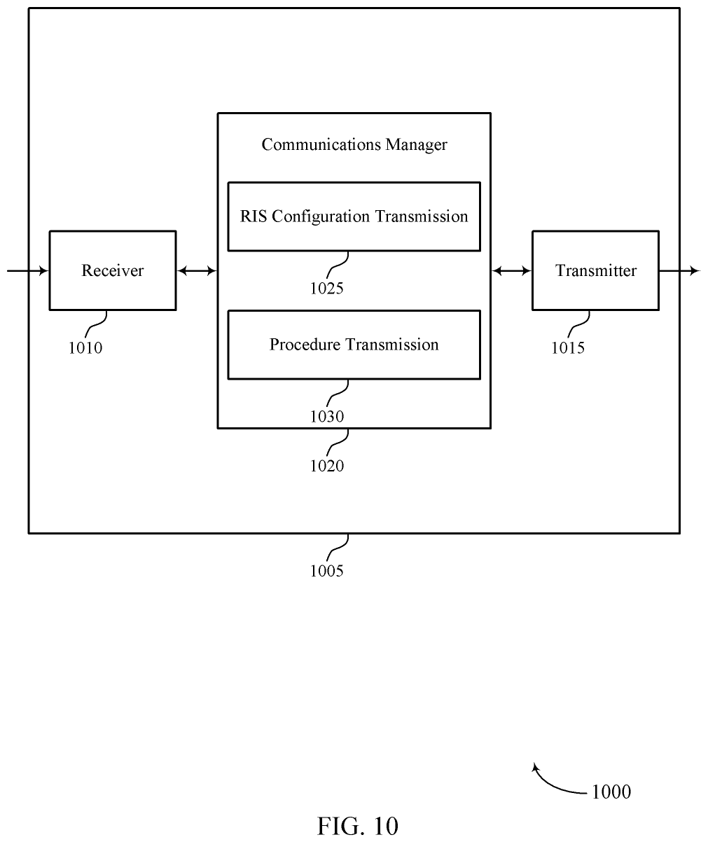

FIG. 10 shows a block diagram 1000 of a device 1005 that supports multiple stages of beamforming for reflective surfaces in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of multiple stages of beamforming for reflective surfaces as described herein. For example, the communications manager 1020 may include a RIS configuration transmission 1025 a procedure transmission 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The RIS configuration transmission 1025 may be configured as or otherwise support a means for transmitting a first message indicating a multi-stage beamforming configuration for a RIS, the multi-stage beamforming configuration pertaining to a set of multiple stages that includes a first stage and one or more second stages that each refine one or more characteristics of the first stage. The procedure transmission 1030 may be configured as or otherwise support a means for transmitting a second message indicating a beam training procedure for at least one of the set of multiple stages of the multi-stage beamforming configuration.

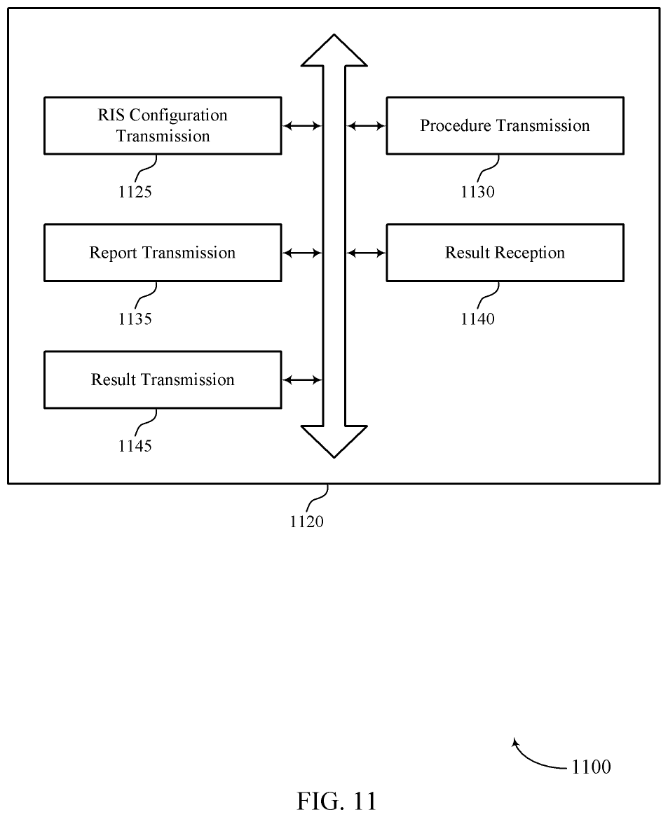

FIG. 11 shows a block diagram 1100 of a communications manager 1120 that supports multiple stages of beamforming for reflective surfaces in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of multiple stages of beamforming for reflective surfaces as described herein. For example, the communications manager 1120 may include a RIS configuration transmission 1125, a procedure transmission 1130, a report transmission 1135, a result reception 1140, a result transmission 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The RIS configuration transmission 1125 may be configured as or otherwise support a means for transmitting a first message indicating a multi-stage beamforming configuration for a RIS, the multi-stage beamforming configuration pertaining to a set of multiple stages that includes a first stage and one or more second stages that each refine one or more characteristics of the first stage. The procedure transmission 1130 may be configured as or otherwise support a means for transmitting a second message indicating a beam training procedure for at least one of the set of multiple stages of the multi-stage beamforming configuration.

In some examples, to support transmitting the first message, the RIS configuration transmission 1125 may be configured as or otherwise support a means for transmitting an indication of the multi-stage beamforming configuration, where, in accordance with the multi-stage beamforming configuration, the first stage is associated with one or more first channel characteristics and at least one of the one or more second stages is associated with one or more second channel characteristics that are of shorter duration than the one or more first channel characteristics.

In some examples, to support transmitting the first message, the RIS configuration transmission 1125 may be configured as or otherwise support a means for transmitting an indication of the multi-stage beamforming configuration, where, in accordance with the multi-stage beamforming configuration, the first stage is associated with a wideband frequency band and at least one of the one or more second stages is associated with a narrowband frequency band that includes a subset of frequencies of the wideband frequency band.

In some examples, to support transmitting the first message, the RIS configuration transmission 1125 may be configured as or otherwise support a means for transmitting an indication of the multi-stage beamforming configuration, where, in accordance with the multi-stage beamforming configuration, the first stage is associated with a common beam for uplink and downlink communications and at least one of the one or more second stages is associated with one or more differences between the uplink and downlink communications.

In some examples, to support transmitting the first message, the RIS configuration transmission 1125 may be configured as or otherwise support a means for transmitting an indication of the multi-stage beamforming configuration, where, in accordance with the multi-stage beamforming configuration, the first stage is associated with an entire reflective surface of the RIS and at least one of the one or more second stages is associated with one or more subsets of the entire reflective surface of the RIS.

In some examples, each stage of the set of multiple stages is associated with a respective phase granularity.

In some examples, each stage of the set of multiple stages is associated with a respective codebook.

In some examples, to support transmitting the second message indicating the beam training procedure, the procedure transmission 1130 may be configured as or otherwise support a means for transmitting an indication to perform the beam training procedure for two or more stages of the set of multiple stages of the multi-stage beamforming configuration.

In some examples, to support transmitting the second message indicating the beam training procedure, the procedure transmission 1130 may be configured as or otherwise support a means for transmitting an indication of a set of RSs for the beam training procedure, the set of RSs associated with the at least one of the set of multiple stages.

In some examples, to support transmitting the second message indicating the beam training procedure, the procedure transmission 1130 may be configured as or otherwise support a means for transmitting an indication of a set of RSs for the beam training procedure and an indication of the at least one of the set of multiple stages.

In some examples, each stage of the set of multiple stages is associated with a respective resource configuration for beam training procedures.

In some examples, RSs associated with the one or more second stages have a lower periodicity than RSs associated with the first stage.

In some examples, a parameter reported for the beam training procedure is based on the at least one of the set of multiple stages.

In some examples, to support transmitting the second message indicating the beam training procedure, the procedure transmission 1130 may be configured as or otherwise support a means for transmitting an indication of the at least one of the set of multiple stages and an indication of a content of a report for the beam training procedure, the content of the report based on the at least one of the set of multiple stages.

In some examples, the RIS configuration transmission 1125 may be configured as or otherwise support a means for transmitting the first message indicating the set of multiple stages. In some examples, the report transmission 1135 may be configured as or otherwise support a means for transmitting a third message indicating a respective content of a report for beam training procedures for each of the set of multiple stages.

In some examples, to support transmitting the first message indicating the multi-stage beamforming configuration, the RIS configuration transmission 1125 may be configured as or otherwise support a means for transmitting an indication of the set of multiple stages and an indication of a respective content of a report for beam training procedures for each of the set of multiple stages.

In some examples, the result reception 1140 may be configured as or otherwise support a means for receiving an indication of a result of the beam training procedure for the at least one of the set of multiple stages based on performing the beam training procedure with the RIS. In some examples, the result transmission 1145 may be configured as or otherwise support a means for transmitting the indication of the result of the beam training procedure to a controller of the RIS.

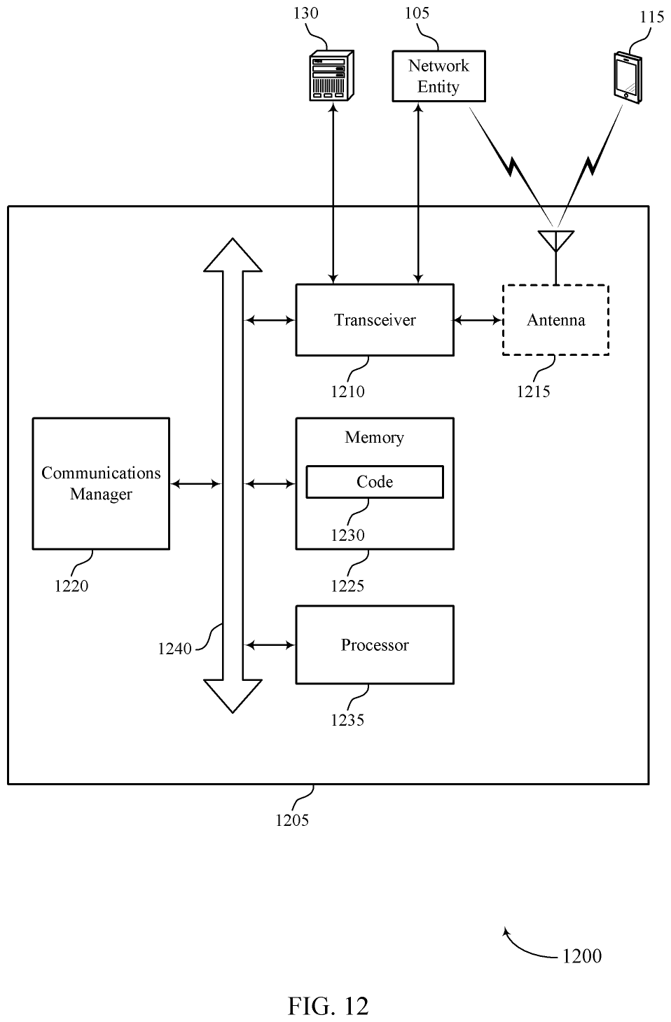

FIG. 12 shows a diagram of a system 1200 including a device 1205 that supports multiple stages of beamforming for reflective surfaces in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting multiple stages of beamforming for reflective surfaces). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting a first message indicating a multi-stage beamforming configuration for a RIS, the multi-stage beamforming configuration pertaining to a set of multiple stages that includes a first stage and one or more second stages that each refine one or more characteristics of the first stage. The communications manager 1220 may be configured as or otherwise support a means for transmitting a second message indicating a beam training procedure for at least one of the set of multiple stages of the multi-stage beamforming configuration.

By including or configuring the communications manager 1220 in accordance with examples as described herein, the device 1205 may support techniques for improved communication reliability, reduced power consumption, more efficient utilization of communication resources, improved coordination between devices, longer battery life, and improved user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of multiple stages of beamforming for reflective surfaces as described herein, or the processor 1235 and the memory 1225 may be otherwise configured to perform or support such operations.

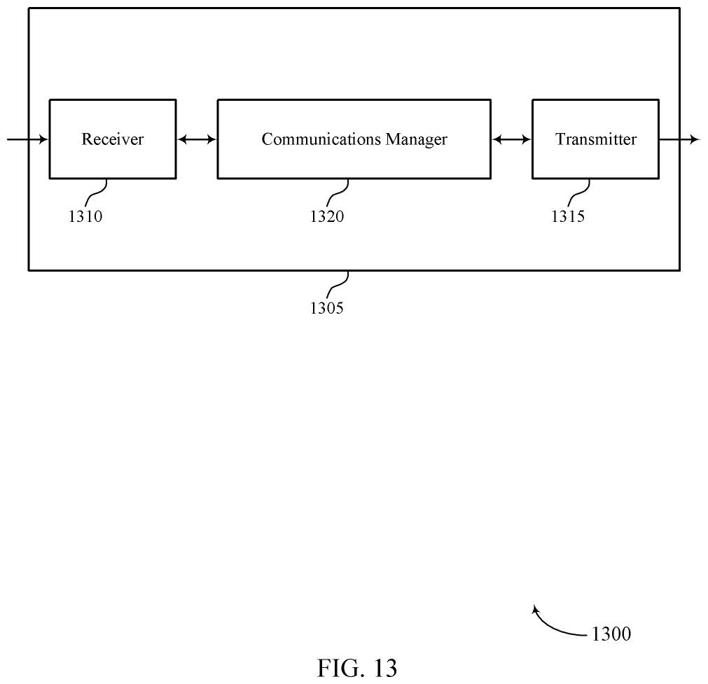

FIG. 13 shows a block diagram 1300 of a device 1305 that supports multiple stages of beamforming for reflective surfaces in accordance with one or more aspects of the present disclosure. The device 1305 may be an example of aspects of a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to multiple stages of beamforming for reflective surfaces). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to multiple stages of beamforming for reflective surfaces). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of multiple stages of beamforming for reflective surfaces as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a UE in accordance with examples as disclosed herein. For example, the communications manager 1320 may be configured as or otherwise support a means for receiving, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage. The communications manager 1320 may be configured as or otherwise support a means for receiving a second message indicating a beam training procedure for at least one of the set of multiple stages of the multi-stage beamforming configuration. The communications manager 1320 may be configured as or otherwise support a means for transmitting an indication of a result of the beam training procedure for the at least one of the set of multiple stages based on performing the beam training procedure with the RIS.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced power consumption and more efficient utilization of communication resources.

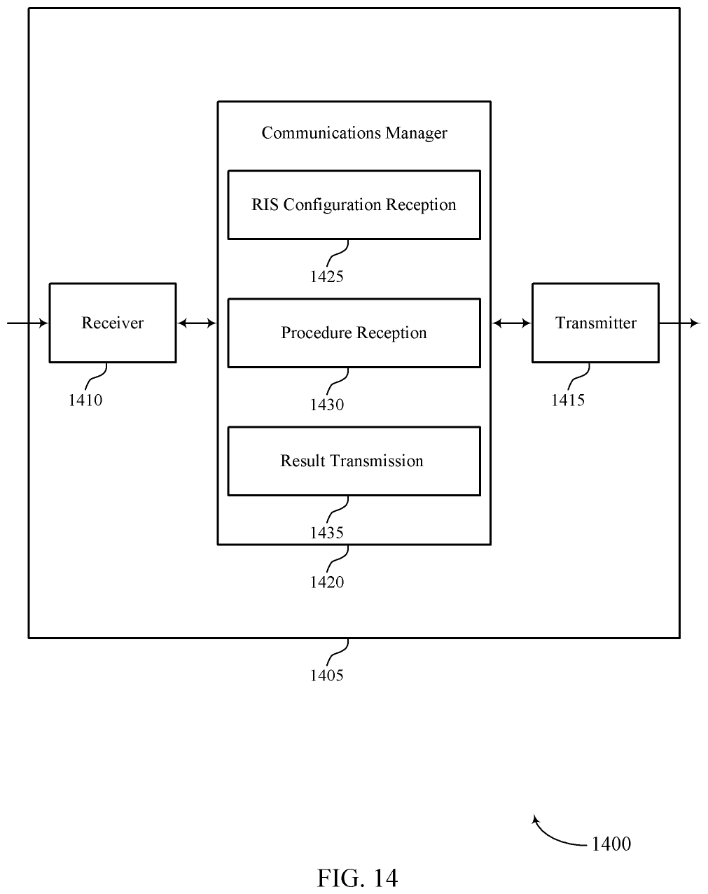

FIG. 14 shows a block diagram 1400 of a device 1405 that supports multiple stages of beamforming for reflective surfaces in accordance with one or more aspects of the present disclosure. The device 1405 may be an example of aspects of a device 1305 or a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to multiple stages of beamforming for reflective surfaces). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to multiple stages of beamforming for reflective surfaces). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of multiple stages of beamforming for reflective surfaces as described herein. For example, the communications manager 1420 may include a RIS configuration reception 1425, a procedure reception 1430, a result transmission 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a UE in accordance with examples as disclosed herein. The RIS configuration reception 1425 may be configured as or otherwise support a means for receiving, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage. The procedure reception 1430 may be configured as or otherwise support a means for receiving a second message indicating a beam training procedure for at least one of the set of multiple stages of the multi-stage beamforming configuration. The result transmission 1435 may be configured as or otherwise support a means for transmitting an indication of a result of the beam training procedure for the at least one of the set of multiple stages based on performing the beam training procedure with the RIS.

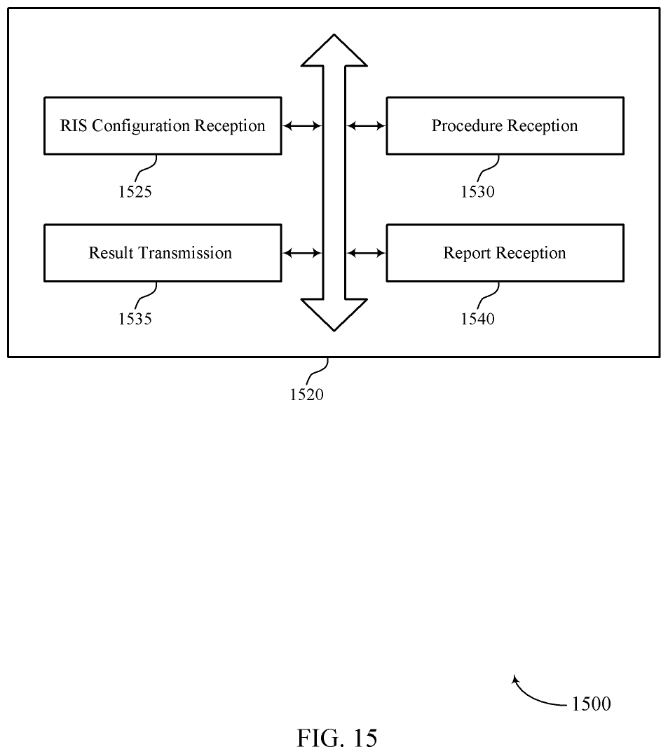

FIG. 15 shows a block diagram 1500 of a communications manager 1520 that supports multiple stages of beamforming for reflective surfaces in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of multiple stages of beamforming for reflective surfaces as described herein. For example, the communications manager 1520 may include a RIS configuration reception 1525, a procedure reception 1530, a result transmission 1535, a report reception 1540, or any combination thereof. Each of these components may communicate, directly or indirectly, with one another (e.g., via one or more buses).

The communications manager 1520 may support wireless communication at a UE in accordance with examples as disclosed herein. The RIS configuration reception 1525 may be configured as or otherwise support a means for receiving, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage. The procedure reception 1530 may be configured as or otherwise support a means for receiving a second message indicating a beam training procedure for at least one of the set of multiple stages of the multi-stage beamforming configuration. The result transmission 1535 may be configured as or otherwise support a means for transmitting an indication of a result of the beam training procedure for the at least one of the set of multiple stages based on performing the beam training procedure with the RIS.

In some examples, to support receiving the second message indicating the beam training procedure, the procedure reception 1530 may be configured as or otherwise support a means for receiving an indication to perform the beam training procedure for two or more stages of the set of multiple stages of the multi-stage beamforming configuration.

In some examples, to support receiving the second message indicating the beam training procedure, the procedure reception 1530 may be configured as or otherwise support a means for receiving an indication of a set of RSs for the beam training procedure, the set of RSs associated with the at least one of the set of multiple stages.

In some examples, to support receiving the second message indicating the beam training procedure, the procedure reception 1530 may be configured as or otherwise support a means for receiving an indication of a set of RSs for the beam training procedure and an indication of the at least one of the set of multiple stages.

In some examples, to support receiving the second message indicating the beam training procedure, the procedure reception 1530 may be configured as or otherwise support a means for receiving an indication of the at least one of the set of multiple stages and an indication of a content of a report for the beam training procedure, the content of the report based on the at least one of the set of multiple stages.

In some examples, the RIS configuration reception 1525 may be configured as or otherwise support a means for receiving the first message indicating the set of multiple stages. In some examples, the report reception 1540 may be configured as or otherwise support a means for receiving a third message indicating a respective content of a report for beam training procedures for each of the set of multiple stages.

In some examples, to support receiving the first message indicating the multi-stage beamforming configuration, the RIS configuration reception 1525 may be configured as or otherwise support a means for receiving an indication of the set of multiple stages and an indication of a respective content of a report for beam training procedures for each of the set of multiple stages.

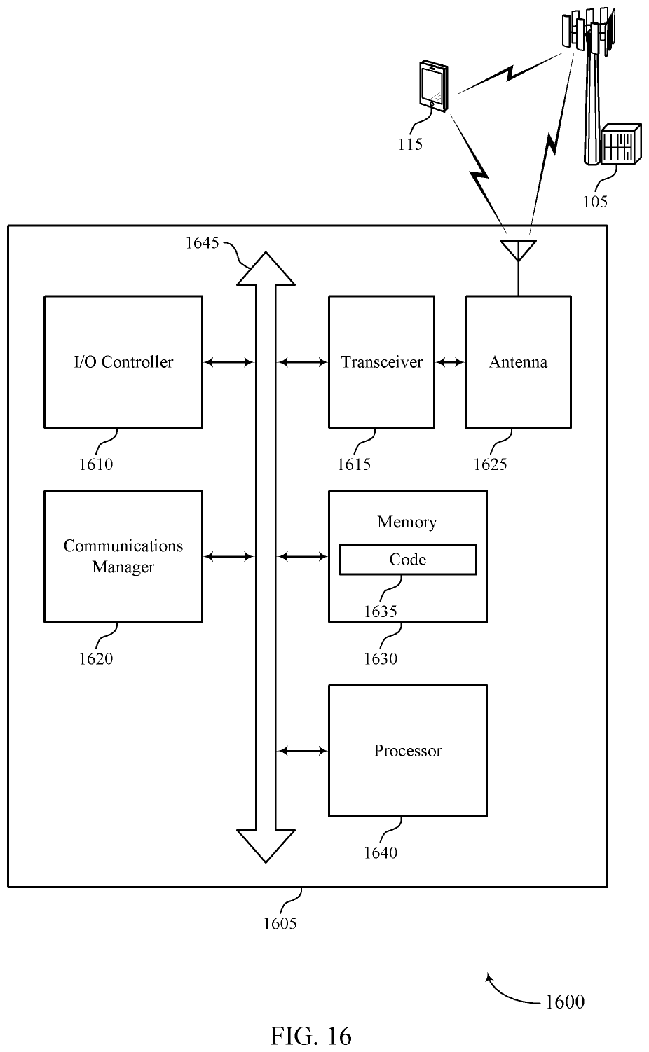

FIG. 16 shows a diagram of a system 1600 including a device 1605 that supports multiple stages of beamforming for reflective surfaces in accordance with one or more aspects of the present disclosure. The device 1605 may be an example of or include the components of a device 1305, a device 1405, or a UE 115 as described herein. The device 1605 may communicate (e.g., wirelessly) with one or more network entities 105, one or more UEs 115, or any combination thereof. The device 1605 may include components for bi-directional voice and data communications including components for transmitting and receiving communications, such as a communications manager 1620, an input/output (I/O) controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include random access memory (RAM) and read-only memory (ROM). The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a basic I/O system (BIOS) which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting multiple stages of beamforming for reflective surfaces). For example, the device 1605 or a component of the device 1605 may include a processor 1640 and memory 1630 coupled with or to the processor 1640, the processor 1640 and memory 1630 configured to perform various functions described herein.

The communications manager 1620 may support wireless communication at a UE in accordance with examples as disclosed herein. For example, the communications manager 1620 may be configured as or otherwise support a means for receiving, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage. The communications manager 1620 may be configured as or otherwise support a means for receiving a second message indicating a beam training procedure for at least one of the set of multiple stages of the multi-stage beamforming configuration. The communications manager 1620 may be configured as or otherwise support a means for transmitting an indication of a result of the beam training procedure for the at least one of the set of multiple stages based on performing the beam training procedure with the RIS.

By including or configuring the communications manager 1620 in accordance with examples as described herein, the device 1605 may support techniques for improved communication reliability, reduced power consumption, more efficient utilization of communication resources, improved coordination between devices, longer battery life, and improved user experience.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of multiple stages of beamforming for reflective surfaces as described herein, or the processor 1640 and the memory 1630 may be otherwise configured to perform or support such operations.

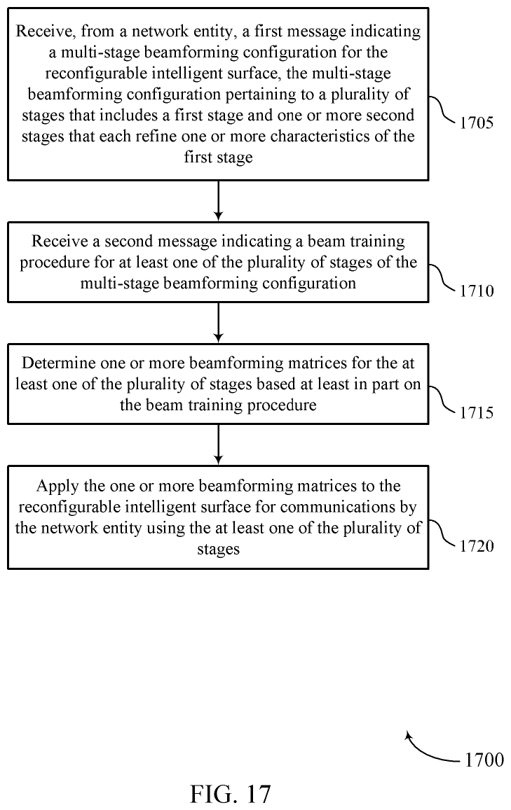

FIG. 17 shows a flowchart illustrating a method 1700 that supports multiple stages of beamforming for reflective surfaces in accordance with one or more aspects of the present disclosure. The operations of the method 1700 may be implemented by a RIS controller or its components as described herein. For example, the operations of the method 1700 may be performed by a RIS controller as described with reference to FIGS. 1 through 8. In some examples, a RIS controller may execute a set of instructions to control the functional elements of the RIS controller to perform the described functions. Additionally, or alternatively, the RIS controller may perform aspects of the described functions using special-purpose hardware.

At 1705, the method may include receiving, from a network entity, a first message indicating a multi-stage beamforming configuration for the RIS, the multi-stage beamforming configuration pertaining to a set of multiple stages that includes a first stage and one or more second stages that each refine one or more characteristics of the first stage. The operations of 1705 may be performed in accordance with examples as disclosed herein. In some examples, aspects of the operations of 1705 may be performed by a RIS configuration reception 725 as described with reference to FIG. 7.

At 1710, the method may include receiving a second message indicating a beam training procedure for at least one of the set of multiple stages of the multi-stage beamforming configuration. The operations of 1710 may be performed in accordance with examples as disclosed herein. In some examples, aspects of the operations of 1710 may be performed by a procedure reception 730 as described with reference to FIG. 7.

At 1715, the method may include determining one or more beamforming matrices for the at least one of the set of multiple stages based on the beam training procedure. The operations of 1715 may be performed in accordance with examples as disclosed herein. In some examples, aspects of the operations of 1715 may be performed by a matrices component 735 as described with reference to FIG. 7.

At 1720, the method may include applying the one or more beamforming matrices to the RIS for communications by the network entity using the at least one of the set of multiple stages. The operations of 1720 may be performed in accordance with examples as disclosed herein. In some examples, aspects of the operations of 1720 may be performed by a matrices component 735 as described with reference to FIG. 7.

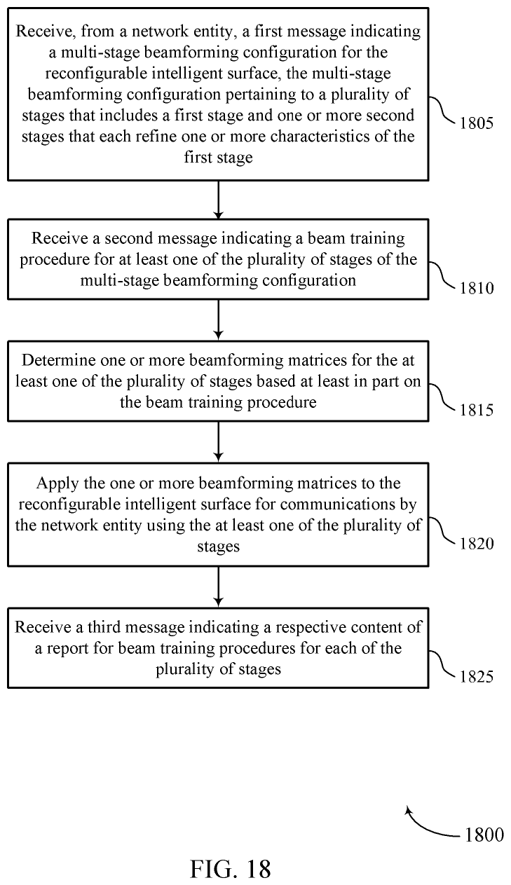

FIG. 18 shows a flowchart illustrating a method 1800 that supports multiple stages of beamforming for reflective surfaces in accordance with one or more aspects of the present disclosure. The operations of the method 1800 may be implemented by a RIS controller or its components as described herein. For example, the operations of the method 1800 may be performed by a RIS controller as described with reference to FIGS. 1 through 8. In some examples, a RIS controller may execute a set of instructions to control the functional elements of the RIS controller to perform the described functions. Additionally, or alternatively, the RIS controller may perform aspects of the described functions using special-purpose hardware.

At 1805, the method may include receiving, from a network entity, a first message indicating a multi-stage beamforming configuration for the RIS, the multi-stage beamforming configuration pertaining to a set of multiple stages that includes a first stage and one or more second stages that each refine one or more characteristics of the first stage. The operations of 1805 may be performed in accordance with examples as disclosed herein. In some examples, aspects of the operations of 1805 may be performed by a RIS configuration reception 725 as described with reference to FIG. 7.

At 1810, the method may include receiving a second message indicating a beam training procedure for at least one of the set of multiple stages of the multi-stage beamforming configuration. The operations of 1810 may be performed in accordance with examples as disclosed herein. In some examples, aspects of the operations of 1810 may be performed by a procedure reception 730 as described with reference to FIG. 7.

At 1815, the method may include determining one or more beamforming matrices for the at least one of the set of multiple stages based on the beam training procedure. The operations of 1815 may be performed in accordance with examples as disclosed herein. In some examples, aspects of the operations of 1815 may be performed by a matrices component 735 as described with reference to FIG. 7.

At 1820, the method may include applying the one or more beamforming matrices to the RIS for communications by the network entity using the at least one of the set of multiple stages. The operations of 1820 may be performed in accordance with examples as disclosed herein. In some examples, aspects of the operations of 1820 may be performed by a matrices component 735 as described with reference to FIG. 7.

At 1825, the method may include receiving a third message indicating a respective content of a report for beam training procedures for each of the set of multiple stages. The operations of 1825 may be performed in accordance with examples as disclosed herein. In some examples, aspects of the operations of 1825 may be performed by a report reception 740 as described with reference to FIG. 7.

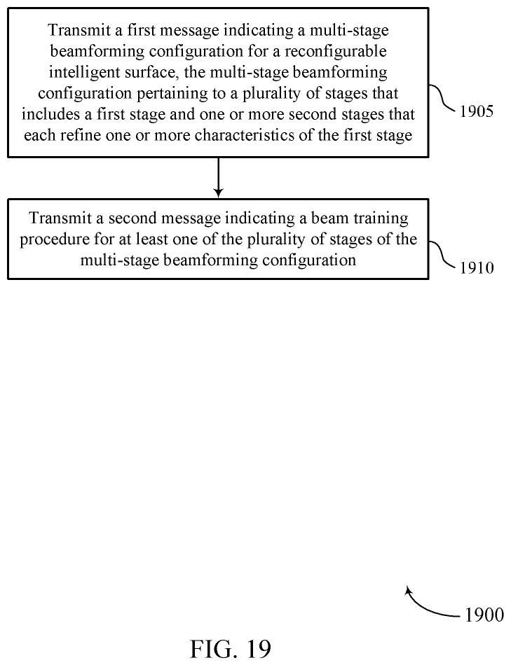

FIG. 19 shows a flowchart illustrating a method 1900 that supports multiple stages of beamforming for reflective surfaces in accordance with one or more aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a first message indicating a multi-stage beamforming configuration for a RIS, the multi-stage beamforming configuration pertaining to a set of multiple stages that includes a first stage and one or more second stages that each refine one or more characteristics of the first stage. The operations of 1905 may be performed in accordance with examples as disclosed herein. In some examples, aspects of the operations of 1905 may be performed by a RIS configuration transmission 1125 as described with reference to FIG. 11.

At 1910, the method may include transmitting a second message indicating a beam training procedure for at least one of the set of multiple stages of the multi-stage beamforming configuration. The operations of 1910 may be performed in accordance with examples as disclosed herein. In some examples, aspects of the operations of 1910 may be performed by a procedure transmission 1130 as described with reference to FIG. 11.

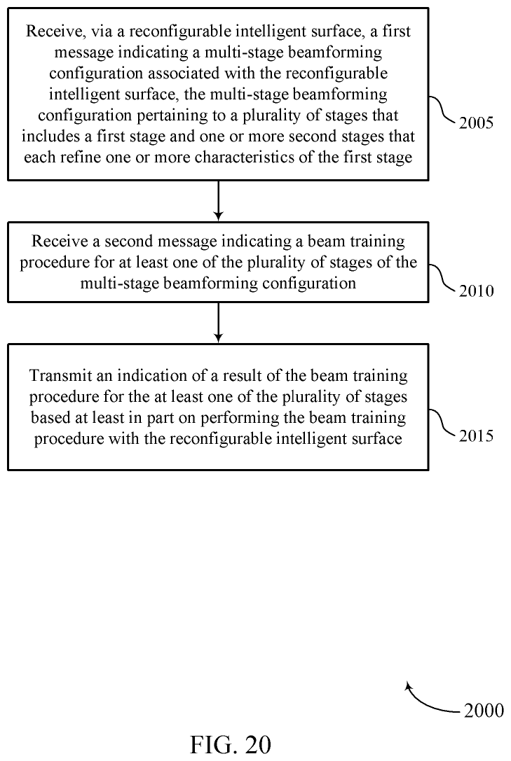

FIG. 20 shows a flowchart illustrating a method 2000 that supports multiple stages of beamforming for reflective surfaces in accordance with one or more aspects of the present disclosure. The operations of the method 2000 may be implemented by a UE or its components as described herein. For example, the operations of the method 2000 may be performed by a UE 115 as described with reference to FIGS. 1 through 4 and 13 through 16. In some examples, a UE may execute a set of instructions to control the functional elements of the UE to perform the described functions. Additionally, or alternatively, the UE may perform aspects of the described functions using special-purpose hardware.

At 2005, the method may include receiving, via a RIS, a first message indicating a multi-stage beamforming configuration associated with the RIS, the multi-stage beamforming configuration pertaining to a set of multiple stages that includes a first stage and one or more second stages that each refine one or more characteristics of the first stage. The operations of 2005 may be performed in accordance with examples as disclosed herein. In some examples, aspects of the operations of 2005 may be performed by a RIS configuration reception 1525 as described with reference to FIG. 15.

At 2010, the method may include receiving a second message indicating a beam training procedure for at least one of the set of multiple stages of the multi-stage beamforming configuration. The operations of 2010 may be performed in accordance with examples as disclosed herein. In some examples, aspects of the operations of 2010 may be performed by a procedure reception 1530 as described with reference to FIG. 15.

At 2015, the method may include transmitting an indication of a result of the beam training procedure for the at least one of the set of multiple stages based on performing the beam training procedure with the RIS. The operations of 2015 may be performed in accordance with examples as disclosed herein. In some examples, aspects of the operations of 2015 may be performed by a result transmission 1535 as described with reference to FIG. 15.

The following provides an overview of aspects of the present disclosure:

Aspect 1: A method for wireless communication at a controller of a RIS, comprising: receiving, from a network entity, a first message indicating a multi-stage beamforming configuration for the RIS, the multi-stage beamforming configuration pertaining to a plurality of stages that includes a first stage and one or more second stages that each refine one or more characteristics of the first stage; receiving a second message indicating a beam training procedure for at least one of the plurality of stages of the multi-stage beamforming configuration; determining one or more beamforming matrices for the at least one of the plurality of stages based at least in part on the beam training procedure; and applying the one or more beamforming matrices to the RIS for communications by the network entity using the at least one of the plurality of stages.

Aspect 2: The method of aspect 1, wherein receiving the first message comprises: receiving an indication of the multi-stage beamforming configuration, wherein, in accordance with the multi-stage beamforming configuration, the first stage is associated with one or more first channel characteristics and at least one of the one or more second stages is associated with one or more second channel characteristics that are of shorter duration than the one or more first channel characteristics.

Aspect 3: The method of any of aspects 1 through 2, wherein receiving the first message comprises: receiving an indication of the multi-stage beamforming configuration, wherein, in accordance with the multi-stage beamforming configuration, the first stage is associated with a wideband frequency band and at least one of the one or more second stages is associated with a narrowband frequency band that includes a subset of frequencies of the wideband frequency band.

Aspect 4: The method of any of aspects 1 through 3, wherein receiving the first message comprises: receiving an indication of the multi-stage beamforming configuration, wherein, in accordance with the multi-stage beamforming configuration, the first stage is associated with a common beam for uplink and downlink communications and at least one of the one or more second stages is associated with one or more differences between the uplink and downlink communications.

Aspect 5: The method of any of aspects 1 through 4, wherein receiving the first message comprises: receiving an indication of the multi-stage beamforming configuration, wherein, in accordance with the multi-stage beamforming configuration, the first stage is associated with an entire reflective surface of the RIS and at least one of the one or more second stages is associated with one or more subsets of the entire reflective surface of the RIS.

Aspect 6: The method of any of aspects 1 through 5, wherein each stage of the plurality of stages is associated with a respective phase granularity.

Aspect 7: The method of any of aspects 1 through 5, wherein each stage of the plurality of stages is associated with a respective codebook.

Aspect 8: The method of any of aspects 1 through 7, wherein receiving the second message indicating the beam training procedure comprises: receiving an indication to perform the beam training procedure for two or more stages of the plurality of stages of the multi-stage beamforming configuration.

Aspect 9: The method of any of aspects 1 through 8, wherein receiving the second message indicating the beam training procedure comprises: receiving an indication of a set of RSs for the beam training procedure, the set of RSs associated with the at least one of the plurality of stages.

Aspect 10: The method of any of aspects 1 through 8, wherein receiving the second message indicating the beam training procedure comprises: receiving an indication of a set of RSs for the beam training procedure and an indication of the at least one of the plurality of stages.

Aspect 11: The method of any of aspects 1 through 10, wherein each stage of the plurality of stages is associated with a respective resource configuration for beam training procedures.

Aspect 12: The method of any of aspects 1 through 11, wherein RSs associated with the one or more second stages have a lower periodicity than RSs associated with the first stage.

Aspect 13: The method of any of aspects 1 through 12, wherein a parameter reported for the beam training procedure is based at least in part on the at least one of the plurality of stages.

Aspect 14: The method of any of aspects 1 through 13, wherein receiving the second message indicating the beam training procedure comprises: receiving an indication of the at least one of the plurality of stages and an indication of a content of a report for the beam training procedure, the content of the report based at least in part on the at least one of the plurality of stages.

Aspect 15: The method of any of aspects 1 through 13, further comprising: receiving the first message indicating the plurality of stages; and receiving a third message indicating a respective content of a report for beam training procedures for each of the plurality of stages.

Aspect 16: The method of any of aspects 1 through 13, wherein receiving the first message indicating the multi-stage beamforming configuration comprises: receiving an indication of the plurality of stages and an indication of a respective content of a report for beam training procedures for each of the plurality of stages.

Aspect 17: The method of any of aspects 1 through 16, further comprising: receiving an indication of a result of the beam training procedure for the at least one of the plurality of stages based at least in part on the beam training procedure, wherein determining the one or more beamforming matrices is based at least in part on receiving the indication of the result.

Aspect 18: A method for wireless communication at a network entity, comprising: transmitting a first message indicating a multi-stage beamforming configuration for a RIS, the multi-stage beamforming configuration pertaining to a plurality of stages that includes a first stage and one or more second stages that each refine one or more characteristics of the first stage; and transmitting a second message indicating a beam training procedure for at least one of the plurality of stages of the multi-stage beamforming configuration.

Aspect 19: The method of aspect 18, wherein transmitting the first message comprises: transmitting an indication of the multi-stage beamforming configuration, wherein, in accordance with the multi-stage beamforming configuration, the first stage is associated with one or more first channel characteristics and at least one of the one or more second stages is associated with one or more second channel characteristics that are of shorter duration than the one or more first channel characteristics.

Aspect 20: The method of any of aspects 18 through 19, wherein transmitting the first message comprises: transmitting an indication of the multi-stage beamforming configuration, wherein, in accordance with the multi-stage beamforming configuration, the first stage is associated with a wideband frequency band and at least one of the one or more second stages is associated with a narrowband frequency band that includes a subset of frequencies of the wideband frequency band.

Aspect 21: The method of any of aspects 18 through 20, wherein transmitting the first message comprises: transmitting an indication of the multi-stage beamforming configuration, wherein, in accordance with the multi-stage beamforming configuration, the first stage is associated with a common beam for uplink and downlink communications and at least one of the one or more second stages is associated with one or more differences between the uplink and downlink communications.

Aspect 22: The method of any of aspects 18 through 21, wherein transmitting the first message comprises: transmitting an indication of the multi-stage beamforming configuration, wherein, in accordance with the multi-stage beamforming configuration, the first stage is associated with an entire reflective surface of the RIS and at least one of the one or more second stages is associated with one or more subsets of the entire reflective surface of the RIS.

Aspect 23: The method of any of aspects 18 through 22, wherein each stage of the plurality of stages is associated with a respective phase granularity.

Aspect 24: The method of any of aspects 18 through 22, wherein each stage of the plurality of stages is associated with a respective codebook.

Aspect 25: The method of any of aspects 18 through 24, wherein transmitting the second message indicating the beam training procedure comprises: transmitting an indication to perform the beam training procedure for two or more stages of the plurality of stages of the multi-stage beamforming configuration.

Aspect 26: The method of any of aspects 18 through 25, wherein transmitting the second message indicating the beam training procedure comprises: transmitting an indication of a set of RSs for the beam training procedure, the set of RSs associated with the at least one of the plurality of stages.

Aspect 27: The method of any of aspects 18 through 25, wherein transmitting the second message indicating the beam training procedure comprises: transmitting an indication of a set of RSs for the beam training procedure and an indication of the at least one of the plurality of stages.

Aspect 28: The method of any of aspects 18 through 27, wherein each stage of the plurality of stages is associated with a respective resource configuration for beam training procedures.

Aspect 29: The method of any of aspects 18 through 28, wherein RSs associated with the one or more second stages have a lower periodicity than RSs associated with the first stage.

Aspect 30: The method of any of aspects 18 through 29, wherein a parameter reported for the beam training procedure is based at least in part on the at least one of the plurality of stages.

Aspect 31: The method of any of aspects 18 through 30, wherein transmitting the second message indicating the beam training procedure comprises: transmitting an indication of the at least one of the plurality of stages and an indication of a content of a report for the beam training procedure, the content of the report based at least in part on the at least one of the plurality of stages.

Aspect 32: The method of any of aspects 18 through 30, further comprising: transmitting the first message indicating the plurality of stages; and transmitting a third message indicating a respective content of a report for beam training procedures for each of the plurality of stages.

Aspect 33: The method of any of aspects 18 through 30, wherein transmitting the first message indicating the multi-stage beamforming configuration comprises: transmitting an indication of the plurality of stages and an indication of a respective content of a report for beam training procedures for each of the plurality of stages.

Aspect 34: The method of any of aspects 18 through 33, further comprising: receiving an indication of a result of the beam training procedure for the at least one of the plurality of stages based at least in part on performing the beam training procedure with the RIS; and transmitting the indication of the result of the beam training procedure to a controller of the RIS.

Aspect 35: A method for wireless communication at a UE, comprising: receiving, via a RIS, a first message indicating a multi-stage beamforming configuration associated with the RIS, the multi-stage beamforming configuration pertaining to a plurality of stages that includes a first stage and one or more second stages that each refine one or more characteristics of the first stage; receiving a second message indicating a beam training procedure for at least one of the plurality of stages of the multi-stage beamforming configuration; and transmitting an indication of a result of the beam training procedure for the at least one of the plurality of stages based at least in part on performing the beam training procedure with the RIS.

Aspect 36: The method of aspect 35, wherein receiving the second message indicating the beam training procedure comprises: receiving an indication to perform the beam training procedure for two or more stages of the plurality of stages of the multi-stage beamforming configuration.

Aspect 37: The method of any of aspects 35 through 36, wherein receiving the second message indicating the beam training procedure comprises: receiving an indication of a set of RSs for the beam training procedure, the set of RSs associated with the at least one of the plurality of stages.

Aspect 38: The method of any of aspects 35 through 36, wherein receiving the second message indicating the beam training procedure comprises: receiving an indication of a set of RSs for the beam training procedure and an indication of the at least one of the plurality of stages.

Aspect 39: The method of any of aspects 35 through 38, wherein receiving the second message indicating the beam training procedure comprises: receiving an indication of the at least one of the plurality of stages and an indication of a content of a report for the beam training procedure, the content of the report based at least in part on the at least one of the plurality of stages.

Aspect 40: The method of any of aspects 35 through 38, further comprising: receiving the first message indicating the plurality of stages; and receiving a third message indicating a respective content of a report for beam training procedures for each of the plurality of stages.

Aspect 41: The method of any of aspects 35 through 38, wherein receiving the first message indicating the multi-stage beamforming configuration comprises: receiving an indication of the plurality of stages and an indication of a respective content of a report for beam training procedures for each of the plurality of stages.

Aspect 42: An apparatus for wireless communication at a controller of a RIS, comprising a processor; memory coupled with the processor; and instructions stored in the memory and executable by the processor to cause the apparatus to perform a method of any of aspects 1 through 17.

Aspect 43: An apparatus for wireless communication at a controller of a RIS, comprising at least one means for performing a method of any of aspects 1 through 17.

Aspect 44: A non-transitory computer-readable medium storing code for wireless communication at a controller of a RIS, the code comprising instructions executable by a processor to perform a method of any of aspects 1 through 17.

Aspect 45: An apparatus for wireless communication at a network entity, comprising a processor; memory coupled with the processor; and instructions stored in the memory and executable by the processor to cause the apparatus to perform a method of any of aspects 18 through 34.

Aspect 46: An apparatus for wireless communication at a network entity, comprising at least one means for performing a method of any of aspects 18 through 34.

Aspect 47: A non-transitory computer-readable medium storing code for wireless communication at a network entity, the code comprising instructions executable by a processor to perform a method of any of aspects 18 through 34.

Aspect 48: An apparatus for wireless communication at a UE, comprising a processor; memory coupled with the processor; and instructions stored in the memory and executable by the processor to cause the apparatus to perform a method of any of aspects 35 through 41.

Aspect 49: An apparatus for wireless communication at a UE, comprising at least one means for performing a method of any of aspects 35 through 41.

Aspect 50: A non-transitory computer-readable medium storing code for wireless communication at a UE, the code comprising instructions executable by a processor to perform a method of any of aspects 35 through 41.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a controller of a reconfigurable intelligent surface, comprising:
receiving, from a network entity, a first message indicating a multi-stage beamforming configuration for the reconfigurable intelligent surface, the multi-stage beamforming configuration pertaining to a plurality of stages that includes a first stage and one or more second stages that each refine one or more characteristics of the first stage;
receiving a second message indicating a beam training procedure for at least one of the plurality of stages of the multi-stage beamforming configuration;
determining one or more beamforming matrices for the at least one of the plurality of stages based at least in part on the beam training procedure; and
applying the one or more beamforming matrices to the reconfigurable intelligent surface for communications by the network entity using the at least one of the plurality of stages.

2. The method of claim 1, wherein receiving the first message comprises:
receiving an indication of the multi-stage beamforming configuration, wherein, in accordance with the multi-stage beamforming configuration, the first stage is associated with one or more first channel characteristics and at least one of the one or more second stages is associated with one or more second channel characteristics that are of shorter duration than the one or more first channel characteristics.

3. The method of claim 1, wherein receiving the first message comprises:
receiving an indication of the multi-stage beamforming configuration, wherein, in accordance with the multi-stage beamforming configuration, the first stage is associated with a wideband frequency band and at least one of the one or more second stages is associated with a narrowband frequency band that includes a subset of frequencies of the wideband frequency band.

4. The method of claim 1, wherein receiving the first message comprises:
receiving an indication of the multi-stage beamforming configuration, wherein, in accordance with the multi-stage beamforming configuration, the first stage is associated with a common beam for uplink and downlink communications and at least one of the one or more second stages is associated with one or more differences between the uplink and downlink communications.

5. The method of claim 1, wherein receiving the first message comprises:
receiving an indication of the multi-stage beamforming configuration, wherein, in accordance with the multi-stage beamforming configuration, the first stage is associated with an entire reflective surface of the reconfigurable intelligent surface and at least one of the one or more second stages is associated with one or more subsets of the entire reflective surface of the reconfigurable intelligent surface.

6. The method of claim 1, wherein each stage of the plurality of stages is associated with a respective phase granularity.

7. The method of claim 1, wherein each stage of the plurality of stages is associated with a respective codebook.

8. The method of claim 1, wherein receiving the second message indicating the beam training procedure comprises:
receiving an indication to perform the beam training procedure for two or more stages of the plurality of stages of the multi-stage beamforming configuration.

9. The method of claim 1, wherein receiving the second message indicating the beam training procedure comprises:
receiving an indication of a set of reference signals for the beam training procedure, the set of reference signals associated with the at least one of the plurality of stages.

10. The method of claim 1, wherein receiving the second message indicating the beam training procedure comprises:
receiving an indication of a set of reference signals for the beam training procedure and an indication of the at least one of the plurality of stages.

11. The method of claim 1, wherein each stage of the plurality of stages is associated with a respective resource configuration for beam training procedures.

12. The method of claim 1, wherein reference signals associated with the one or more second stages have a lower periodicity than reference signals associated with the first stage.

13. The method of claim 1, wherein a parameter reported for the beam training procedure is based at least in part on the at least one of the plurality of stages.

14. The method of claim 1, wherein receiving the second message indicating the beam training procedure comprises:
receiving an indication of the at least one of the plurality of stages and an indication of a content of a report for the beam training procedure, the content of the report based at least in part on the at least one of the plurality of stages.

15. The method of claim 1, further comprising:
receiving the first message indicating the plurality of stages; and
receiving a third message indicating a respective content of a report for beam training procedures for each of the plurality of stages.

16. The method of claim 1, wherein receiving the first message indicating the multi-stage beamforming configuration comprises:
receiving an indication of the plurality of stages and an indication of a respective content of a report for beam training procedures for each of the plurality of stages.

17. The method of claim 1, further comprising:
receiving an indication of a result of the beam training procedure for the at least one of the plurality of stages based at least in part on the beam training procedure, wherein determining the one or more beamforming matrices is based at least in part on receiving the indication of the result.

18. An apparatus for wireless communication at a controller of a reconfigurable intelligent surface, comprising:
a processor;
memory coupled with the processor; and
instructions stored in the memory and executable by the processor to cause the apparatus to:
receive, from a network entity, a first message indicating a multi-stage beamforming configuration for the reconfigurable intelligent surface, the multi-stage beamforming configuration pertaining to a plurality of stages that includes a first stage and one or more second stages that each refine one or more characteristics of the first stage;
receive a second message indicating a beam training procedure for at least one of the plurality of stages of the multi-stage beamforming configuration;
determine one or more beamforming matrices for the at least one of the plurality of stages based at least in part on the beam training procedure; and
apply the one or more beamforming matrices to the reconfigurable intelligent surface for communications by the network entity using the at least one of the plurality of stages.

19. The apparatus of claim 18, wherein the instructions to receive the first message are executable by the processor to cause the apparatus to:
receive an indication of the multi-stage beamforming configuration, wherein, in accordance with the multi-stage beamforming configuration, the first stage is associated with one or more first channel characteristics and at least one of the one or more second stages is associated with one or more second channel characteristics that are of shorter duration than the one or more first channel characteristics.

20. The apparatus of claim 18, wherein the instructions to receive the first message are executable by the processor to cause the apparatus to:
receive an indication of the multi-stage beamforming configuration, wherein, in accordance with the multi-stage beamforming configuration, the first stage is associated with a wideband frequency band and at least one of the one or more second stages is associated with a narrowband frequency band that includes a subset of frequencies of the wideband frequency band.

21. The apparatus of claim 18, wherein the instructions to receive the first message are executable by the processor to cause the apparatus to:
receive an indication of the multi-stage beamforming configuration, wherein, in accordance with the multi-stage beamforming configuration, the first stage is associated with a common beam for uplink and downlink communications and at least one of the one or more second stages is associated with one or more differences between the uplink and downlink communications.

22. The apparatus of claim 18, wherein the instructions to receive the first message are executable by the processor to cause the apparatus to:
receive an indication of the multi-stage beamforming configuration, wherein, in accordance with the multi-stage beamforming configuration, the first stage is associated with an entire reflective surface of the reconfigurable intelligent surface and at least one of the one or more second stages is associated with one or more subsets of the entire reflective surface of the reconfigurable intelligent surface.

23. The apparatus of claim 18, wherein each stage of the plurality of stages is associated with a respective phase granularity.

24. The apparatus of claim 18, wherein each stage of the plurality of stages is associated with a respective codebook.

25. The apparatus of claim 18, wherein the instructions to receive the second message indicating the beam training procedure are executable by the processor to cause the apparatus to:
receive an indication to perform the beam training procedure for two or more stages of the plurality of stages of the multi-stage beamforming configuration.

26. The apparatus of claim 18, wherein the instructions to receive the second message indicating the beam training procedure are executable by the processor to cause the apparatus to:
receive an indication of a set of reference signals for the beam training procedure, the set of reference signals associated with the at least one of the plurality of stages.

27. The apparatus of claim 18, wherein the instructions to receive the second message indicating the beam training procedure are executable by the processor to cause the apparatus to:
receive an indication of a set of reference signals for the beam training procedure and an indication of the at least one of the plurality of stages.

28. The apparatus of claim 18, wherein each stage of the plurality of stages is associated with a respective resource configuration for beam training procedures.

29. A method for wireless communication at a network entity, comprising:
transmitting a first message indicating a multi-stage beamforming configuration for a reconfigurable intelligent surface, the multi-stage beamforming configuration pertaining to a plurality of stages that includes a first stage and one or more second stages that each refine one or more characteristics of the first stage; and
transmitting a second message indicating a beam training procedure for at least one of the plurality of stages of the multi-stage beamforming configuration.

30. An apparatus for wireless communication at a network entity, comprising:
a processor;
memory coupled with the processor; and
instructions stored in the memory and executable by the processor to cause the apparatus to:
transmit a first message indicating a multi-stage beamforming configuration for a reconfigurable intelligent surface, the multi-stage beamforming configuration pertaining to a plurality of stages that includes a first stage and one or more second stages that each refine one or more characteristics of the first stage; and
transmit a second message indicating a beam training procedure for at least one of the plurality of stages of the multi-stage beamforming configuration.
